(19) United States
(12) Patent Application Publication
(10) Pub. No.: US 2003/0195840 A1
(43) Pub. Date: Oct. 16, 2003

(54) Methods and apparatus for determining credit limit extensions for financial accounts

(76) Inventor: Tianwei Xu, Norcross, GA (US)

Correspondence Address: BUCKLEY, MASCHOFF, TALWALKAR, & ALLISON, 5 ELM STREET, NEW CANAAN, CT, 06840, US

(21) Appl. No.: 10/107,100

(22) Filed: Mar. 26, 2002

(51) Int. Cl. G06F 17/60

(52) U.S. Cl. 705/38

(57) ABSTRACT

A system, method, apparatus, means, and computer program code for determining allowable credit limit extensions for account holders of financial products and accounts and, more particularly, for determining if an increase of an account holder's credit limit can be allowed during one or more transactions. According to embodiments of the present invention, a method may include determining at least one set of allowable credit limit extensions for a respective at least one segment of account holders of financial products or accounts. If more than one set of allowable credit limit extensions are determined, the method may include determining an objective and selecting one of the sets based on the objective.

### FIELD OF THE INVENTION

The present invention relates to methods and apparatus for determining allowable credit limit extensions for account holders of financial products and accounts and, more particularly, embodiments of the present invention relate to methods, means, apparatus, and computer program code for determining if an increase of an account holder's credit limit associated with a financial product or account can be authorized during one or more transactions.

### BACKGROUND OF THE INVENTION

Generally, financial products such as credit cards have credit or other limits associated with them. That is, a person using a credit card may not be allowed to exceed a limit associated with the credit card. When the person uses the credit at a merchant to make a purchase as part of a transaction, the merchant may request authorization to allow use of the credit card from the issuer of the credit card. If the person tries to use the credit card in a way that might exceed the limit associated with the credit card, the merchant will receive an indication from the credit card issuer that use of the credit card in the purchase or transaction is not authorized.

In some situations, however, the merchant and/or the credit card issuer may want to allow certain people to exceed credit limits associated with their credit cards. Unfortunately, extending or providing credit limit extensions to people increases the risk of losses to the credit card issuer when some or all of the people fail to make payments towards reducing their credit card balances when due. In addition, such losses may offset potential revenue gains generated from allowing other individuals to exceed their credit limits during transactions. Furthermore, one business objective for the card issuer may require that the card issuer deny a request from a merchant to allow an account holder to exceed the account holder's credit card limit while a different business objective for the card issuer may allow the card issuer to approve the request. However, the card issuer is not able to make such decisions on a case-by-case basis when the card issuer has one or more global objectives regarding all individuals that may request extensions to their credit card limits during one or more transactions.

It would be advantageous to provide a method and apparatus that overcame the drawbacks of the prior art. In particular, it would be desirable to provide methods and apparatus for determining credit limit extensions for users of credit cards and other financial accounts. Furthermore, it would be desirable to provide methods and apparatus for determining when to allow credit limit extensions for users of credit cards and other financial accounts in light of one or more business, financial, marketing, or other objectives.

### SUMMARY OF THE INVENTION

Embodiments of the present invention provide a system, method, apparatus, means, and computer program code for determining allowable credit limit extensions for users of financial products and accounts and, more particularly, embodiments of the present invention relate to methods, means, apparatus, and computer program code for determining if an increase of an account holder's credit limit can be allowed during one or more transactions.

According to some embodiments of the present invention, a method for determining credit limit extensions for account holders may include determining sets of possible credit limit extensions for different segments of account holders. One or more business objectives may then be taken into consideration when selecting one of the possible sets to implement for the segments of account holders.

Additional objects, advantages, and novel features of the invention shall be set forth in part in the description that follows, and in part will become apparent to those skilled in the art upon examination of the following or may be learned by the practice of the invention.

According to some embodiments of the present invention, a method for determining credit limit extensions for segments of account holders may include determining a plurality of segments of account holders, wherein each of the account holders has an associated financial account and each of the segments includes at least one of the account holders; determining at least one objective associated with all of the segments; and determining a set of allowable credit limit extensions for the segments based on the at least one objective. In other embodiments, a method for determining credit limit extensions for at least two different segments of account holders may include determining a plurality of segments of account holders, wherein each of the account holders has an associated financial account and each of the segments includes at least one of the account holders; and determining a plurality of sets of allowable credit limit extensions for the segments. In further embodiments, a method for determining credit card limit extensions for account holders of the credit cards may include determining, for a group of segments of account holders of credit cards, a plurality of sets of allowable credit limit extensions; determining at least one objective; and selecting one of the sets of allowable credit limit extensions based, at least in part, on the at least one objective. In yet other embodiments, a method for determining credit card limit extensions for account holders of the credit cards may include determining, for a group of segments of account holders of credit cards, a plurality of sets of allowable credit limit extensions; and selecting one of the sets of allowable credit limit extensions.

According to some embodiments of the present invention, a system for determining credit limit extensions for segments of account holders may include a memory; a communication port; and a processor connected to the memory and the communication port, the processor being operative to determine a plurality of segments of account holders, wherein each of the account holders has an associated financial account and each of the segments includes at least one of the account holders; determine at least one objective associated with all of the segments; and determine a set of allowable credit limit extensions for the segments based on the at least one objective. In other embodiments, a system for determining credit limit extensions for at least two different segments of account holders may include a memory; a communication port; and a processor connected to the memory and the communication port, the processor being operative to determine a plurality of segments of account holders, wherein each of the account holders has an associated financial account and each of the segments includes at least one of the account holders; and determine a plurality of sets of allowable credit limit extensions for the segments. In further embodiments, a system for determining credit card limit extensions for account holders of the credit cards may include a memory; a communication port; and a processor connected to the memory and the communication port, the processor being operative to determine, for a group of segments of account holders of credit cards, a plurality of sets of allowable credit limit extensions; determine at least one objective; and select one of the sets of allowable credit limit extensions based, at least in part, on the at least one objective. In yet other embodiments, a system for determining credit card limit extensions for account holders of the credit cards may include a memory; a communication port; and a processor connected to the memory and the communication port, the processor being operative to determine, for a group of segments of account holders of credit cards, a plurality of sets of allowable credit limit extensions; and select one of the sets of allowable credit limit extensions.

According to some embodiments of the present invention, a computer program product in a computer readable medium for determining credit limit extensions for segments of account holders may include first instructions for identifying a plurality of segments of account holders, wherein each of the account holders has an associated financial account and each of the segments includes at least one of the account holders; second instructions for identifying at least one objective associated with all of the segments; and third instructions for selecting a set of allowable credit limit extensions for the segments based on the at least one objective. In other embodiments, a computer program product in a computer readable medium for determining credit limit extensions for at least two different segments of account holders may include first instructions for identifying a plurality of segments of account holders, wherein each of the account holders has an associated financial account and each of the segments includes at least one of the account holders; and second instructions for identifying a plurality of sets of allowable credit limit extensions for the segments. In further embodiments, a computer program product in a computer readable medium for determining credit card limit extensions for account holders of the credit cards may include first instructions for identifying, for a group of segments of account holders of credit cards, a plurality of sets of allowable credit limit extensions; second instructions for identifying at least one objective; and third instructions for choosing one of the sets of allowable credit limit extensions based, at least in part, on the at least one objective. In yet other embodiments, a computer program product in a computer readable medium for determining credit card limit extensions for account holders of the credit cards may include first instructions for identifying, for a group of segments of account holders of credit cards, a plurality of sets of allowable credit limit extensions; and second instructions for choosing one of the sets of allowable credit limit extensions. In still further embodiments, a computer program product in a computer readable medium for determining sets of potential credit limit extensions for segments of account holders may include first instructions for providing an interface, wherein the interface includes a plurality of adjustable settings for a respective plurality of attributes; and second instructions for determining a plurality of sets of potential credit limit extensions for the segments guided, at least in part, by the plurality of adjustable settings.

According to some embodiments of the present invention, an apparatus for determining credit limit extensions for segments of account holders may include means for identifying a plurality of segments of account holders, wherein each of the account holders has an associated financial account and each of the segments includes at least one of the account holders; means for identifying at least one objective associated with all of the segments; and means for selecting a set of allowable credit limit extensions for the segments based on the at least one objective. In other embodiments, an apparatus for determining credit limit extensions for at least two different segments of account holders may include means for identifying a plurality of segments of account holders, wherein each of the account holders has an associated financial account and each of the segments includes at least one of the account holders; and means for identifying a plurality of sets of allowable credit limit extensions for the segments. In further embodiments, an apparatus in a computer readable medium for determining credit card limit extensions for account holders of the credit cards may include means for identifying, for a group of segments of account holders of credit cards, a plurality of sets of allowable credit limit extensions; means for identifying at least one objective; and means for choosing one of the sets of allowable credit limit extensions based, at least in part, on the at least one objective. In yet other embodiments, an apparatus in a computer readable medium for determining credit card limit extensions for account holders of the credit cards may include means for identifying, for a group of segments of account holders of credit cards, a plurality of sets of allowable credit limit extensions; and means for choosing one of the sets of allowable credit limit extensions.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is an illustration of one example segmentation of account holders that may be used with the method of FIG. 1;

FIG. 3 is a flowchart of one possible implementation of the step of determining a plurality of allowable account holder credit limit extensions of FIG. 1;

FIG. 4 is a flowchart of a second embodiment of a method in accordance with the present invention;

FIG. 5 is a flowchart of a third embodiment of a method in accordance with the present invention;

FIG. 6 is a block diagram of system components for an embodiment of an apparatus usable with the methods of FIGS. 1 and 3-5;

FIG. 7 is a block diagram of components for an embodiment of a server of FIG. 6;

FIG. 8 is an illustration of a representative account holder information database of FIG. 7;

FIG. 9 is an illustration of a representative segment information database of FIG. 7;

FIG. 10 is an illustration of a representative account information database of FIG. 7; and

FIG. 11 is an illustration of a possible interface used in implementations of the methods of the present invention.

### DETAILED DESCRIPTION

Applicants have recognized that there is a need for systems, computer code, means and methods that facilitate determining credit limit extensions for account holders (also referred to as card holders in some embodiments) associated with credit cards or other financial products or accounts and/or that facilitate when a credit limit extension should be provided to an account holder of a financial product or account during one or more transactions. In addition, applicants have recognized that there is a need for systems, computer code, means, and methods that facilitate determining sets of credit limit extensions for segments of account holders of a financial product or account.

As one example, an account holder may have an associated credit card that the account holder wishes to use at a merchant to make a purchase. The credit card may have an associated credit limit of one thousand dollars. During the transaction, the merchant may seek authorization from a credit card issuer that allows the account holder to make the purchase using the credit card. Typically, the credit card issuer will not authorize use of the credit card to make a purchase during a transaction that will make the account holder's credit card balance be more than one thousand dollars. In some cases, however, the merchant and/or the credit card issuer may want to allow the account holder to use the credit card in the transaction, even though the account holder will exceed the credit card limit associated with the credit card. For example, if the account holder consistently pays down the balance on the credit card or if the account holder has never missed making a payment due on a credit card, the merchant and/or the card issuer may be willing to risk increasing or otherwise extending the account holder's credit card limit for the given transaction. Such an increase or credit limit extension may be allowed for the current transaction only, may be allowed for a temporary period of time, or may be permanent, thereby effectively increasing the account holder's credit limit. In some embodiments, an account holder's credit limit may change relatively infrequently while a pad percentage associated with the account holder may change more frequently depending.

For purposes of discussion, but not limitation, of the present invention, a credit limit extension for an account holder refers to an extension provided to the account holder over the account holder's current credit limit. However, providing a credit limit extension to the account holder for purposes of one or more transactions does not necessarily equate to a change in the account holder's associated credit limit, even though the account holder may be allowed to exceed the credit limit as the result of, or during, one or more transactions. For example, an account holder may have a two thousand dollar credit limit associated with a credit card. Suppose that the account holder's current balance for the credit card is $1,500 and the account holder wants to purchase a product for $700 in a transaction using the credit card. Typically, the account holder would not be allowed to make such a purchase with the credit card since in order to do so the account holder would need a two hundred dollar credit limit extension to allow the account holder to exceed the two thousand dollar credit limit by two hundred dollars. However, as discussed above, if the account holder is a good customer, the credit card issuer may authorize the transaction and grant the account holder a two hundred dollar credit limit extension. As a result, the account holder now has a pad percentage of one hundred and ten percent (i.e., 100%×$2,200/$2000). A pad percentage for an account holder or an account is computed relative to the account holder's or the account's current credit limit. Thus, a pad percentage of one hundred percent indicates that an account holder has not been granted any credit limit extension while a pad percentage of ten percent indicates that the account holder can receive a credit limit extension equal to ten percent of the account holder's current credit limit. A pad percentage of less than one hundred percent means that the account holder cannot use all of the associated credit limit until the pad percentage is increased to one hundred percent or more. While the present invention will be discussed primarily in reference to credit limit extensions, in some embodiments an account holder may have a credit limit limitation. Thus, the account holder may have a pad percentage less than one hundred percent or reduced access to full use of the credit limit associated with the account holder.

The systems, computer code, means and methods disclosed herein may be used by a financial products or services company (e.g., a credit card issuer), a merchant, and/or and entity or device on behalf of the financial products or services company or merchant. A merchant may include any type of store, business, on-line retailer, etc. where an account holder may want or try to use a financial product or account during a transaction.

A financial product or account issuer may include banks, lending companies, financial services companies, etc. that provide financial products or accounts to account holders. For example, a financial product issuer may be a company (e.g., Visa) that issues credit or debit cards to account holders and/or manages branded or private labeled credit cards for merchants.

A technical effect provided by the methods, systems, etc. of the present invention is that a user can determine one or more credit limit extensions (if any) to provide to one or more segments of account holders. In addition, the user has the ability to set guidelines for use in establishing or evaluating different potential sets of credit limit extensions for the different segments of account holders. These and other features will be discussed in further detail below, by describing a system, individual devices, and processes according to embodiments of the invention.

Process Description

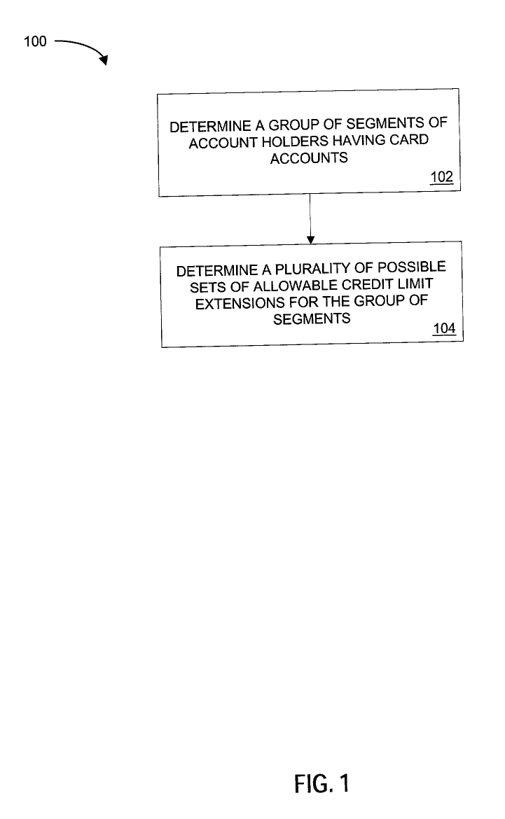

Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a server, merchant, credit card issuer, and/or another device or entity, as will be discussed in more detail below.

Processing begins at a step 102 during which a group of segments of account holders having card (e.g., credit cards, gift cards, charge cards) accounts are identified or otherwise determined. In some embodiments, a device or entity implementing the step 102 may receive or retrieve the account holder segment information from another source or as the output of another process. Alternatively, the device or entity may determine the segments itself. During a step 104, possible sets of allowable credit limit extensions are determined for the segments determined during the step 102, as will be discussed in more detail below.

In some embodiments, account holders may be segmented using one or more of a variety of account holder related criteria. For example, account holders may be segmented according to credit rating or score, credit limit, account balance, recency, (i.e., number of months of consecutive delinquency), demographic information, length of time having or using accounts, purchasing or transaction history using an account, payment delinquency history, payment pattern (e.g., use of revolving credit, pay off of account every month), etc. In some embodiments, information regarding one or more account holders may be stored in, or accessed from, an account holder information database or other resource. Similarly, in some embodiments, information regarding one or more segments of account holders may be stored in, or accessed from, a segment information database or other resource.

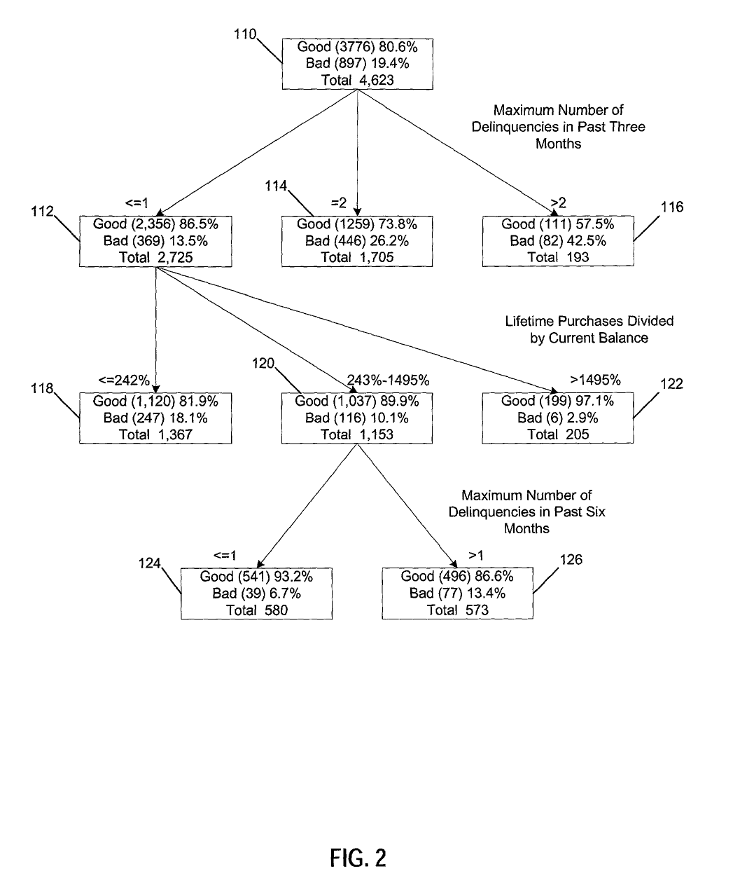

Now referring to FIG. 2, an example segmentation of 4,623 account holders of credit cards is illustrated. For purposes of analysis, the information used to generate the segmentation is based on historical data that covered a time span of twelve months (e.g., Mar. 1, 2001, to Feb. 28, 2002).

As illustrated by block 110, of the 4,623 account holders, 3,776 are considered “good”, which means that none of the 3,776 account holders have had a payment due towards their credit card balances more than ninety days old during the twelve month period and none have not had any portions of their account balances written off during the twelve month period. In addition, of the 4,623 account holders, 897 are considered “bad”, which means that each of the 897 account holders have either had a payment due for more than ninety days at some point during the twelve month period or have had at least some of their account balance written off at some point during the twelve month period. For any “bad” account, the “bad amount” is the sum of all charge amounts made by the account during the twelve month period, even if only a portion of the of total charge amount actually was paid off late or written off. For example, for an account holder that charges one thousand dollars during the twelve month period, but fails to make payments for over ninety days when a payment of two hundred dollars is due, has a bad amount of one thousand dollars, not two hundred dollars. A “bad rate” for a segment is defined as the total segment's account holders' bad amounts for the twelve month period divided by the segment's account holders' total charge amounts during the twelve month period. The terms “good”, “bad”, “bad amount” and “bad rate” as used herein are purely for illustrative purposes and other criteria for segmentation and evaluation may be used.

For purposes of this example, it is desirable to segment good account holders from bad account holders in statistically significant measures. For example, a standard Chi-square analysis could be used to segment account holders based on one or more variables. A Chi-square analysis provides a test of statistical significance for a hypothesis regarding whether or not two different account holders are different with regard to one or more variables such that a generalization can be made from the account holders that segments including the account holders are also different with regard to the one or more variables.

Segmentation of the 4,623 account holders may include a determination of the most significant variable among a set of predefined or designated variables and segmenting the 4,623 account holders according to the variable. For example, blocks 112, 114 and 116 represent segmentation of the 4,623 account holders into three segments with regard to a variable based on the maximum number of delinquencies over the past three months. More specifically, the block 112 includes 2,725 of the 4,623 account holders of the block 110, each of which has had one or less delinquent payment within the past three months. The block 114 includes 1,705 of the 4,623 account holders of the block 110, each of which has had two delinquent payments within the past three months. The block 116 includes 193 of the 4,623 account holders of the block 110, each of which has had more than two delinquent payments within the past three months.

While other variables may have been tested and/or used for the segmentation of the 4623 account holders of the block 110 into the account holders distributed among the blocks 112, 114 and 116, for this example, a Chi-square analysis indicates that that segmentation of the 4,623 according to the number of delinquencies during the past three months is the most statistically significant variable relative to other possible variables.

Once the first block 110 of account holders is segmented into the three blocks 112, 114, 116 of account holders, each of the three blocks 112, 114, 116 is analyzed independently to see if the account holders within the block can be further segmented. For this example, as illustrated in FIG. 2, account holders associated with the blocks 114, 116 cannot be further segmented in a statistically significant way. In contrast, the 2,725 account holders of the block 112 can be further segmented into blocks 118, 120, 122 of account holders by a variable looking at each account holder's lifetime amount of purchases using his or her respective credit card versus the current balance of the credit card. While other variables may have been tested for the account holders in the block 112, lifetime purchase amount of credit card balance is the most statistically significantly based on Chi-square analysis relative to the other variables. The block 118 includes 1,367 of the 2,725 account holders of the block 112, each of which has a percentage of lifetime purchase amount divided by current balance of less than or equal to 242%. The block 120 includes 1153 of the 2,725 account holders of the block 112, each of which has a percentage of lifetime purchase amount divided by current balance greater than 242% and less than or equal to 1,495%. The block 122 includes 205 of the 2,725 account holders of the block 112, each of which has a percentage of lifetime purchase amount divided by current balance greater than 1,495%.

Once the blocks 118, 120, 122 of account holders are created, each of the blocks 118, 120, 122 are further tested or analyzed to see if they can be further segmented. For this example, as illustrated in FIG. 2, account holders associated with the blocks 118, 122 cannot be further segmented in a statistically significant way. In contrast, the 1,153 account holders of the block 120 can be further segmented into blocks 118, 120, 122 of account holders by a variable looking at each account holder's maximum number of delinquencies in the past six months. While other variables may have been tested for the account holders in the block 120, the maximum number of delinquencies in the past six months variable is the most statistically significantly based on Chi-square analysis relative to the other variables. The block 120 of 1,153 account holders can be segmented into a block 124 of account holders and a block 126 of account holders. The block 144 includes 580 of the 1,153 account holders of the block 120, each of which has had one or less delinquent payments within the past six months. The block 126 includes 573 of the 1,153 account holders of the block 120, each of which has had more than one delinquent payment within the past six months.

Once the block 120 of account holders is segmented into the three blocks 124. 126 of account holders, each of the two blocks 124, 126 is analyzed independently to see if the account holders within the block can be further segmented. For this example, as illustrated in FIG. 2, account holders associated with the blocks 124, 126 cannot be further segmented in a statistically significant way. Thus, the 4,623 account holders can be allocated into six segments of account holders represented by the blocks 114, 116, 118, 122, 124 and 126.

Once account holders are segmented, different sets of allowable credit limit extensions or pad percentages are determined for the segments during the step 104. For example, suppose that three account holder segments A, B, C are determined during the step 102. A break-down of the three account holder segments A, B, C by bad rate percentage, total sales and bad sales may be as illustrated in Table 1.

TABLE 1

| Segment A | Segment B | Segment C | | |
|---|---|---|---|---|
| Bad Rate | Bad Rate | Bad Rate | | |
| Percentage | Percentage | Percentage | Total Sales | Bad Sales |
| 12.09% | 15.73% | 3.34% | $357,386.00 | $20,953.00 |

As illustrated in Table 1, segment A has a bad rate percentage of 12.09% (i.e., 12.09% of the account holders in segment A are considered bad), segment B has a bad rate percentage of 15.73%, and segment C has a bad rate percentage of 3.34%. Overall, the account holders in the three segments A, B, C generated $357,386 in total sales during a one month period and $20,953 in bad sales during the same time period. For purposes of this example, account holders in the three segments A, B, C were assumed to generate total sales of $357,386.00 and bad sales or bad amounts of $20,953.00. Each of the three segments A, B, C currently may have a pad percentage of one hundred percent. Thus, none of the account holders in any of the segments A, B, C may be able to exceed the current credit limits for their respective credit cards. Alternatively, the segments A, B currently may have a pad percentage of one hundred percent while the segment C currently may have a pad percentage of one hundred and five percent. Thus, none of the account holders in the segments A, B currently may exceed the credit limits for their respective credit cards. However, account holders in the segment C currently may exceed the credit limits for the respective credit cards by five percent.

As will be discussed in more detail below, in some embodiments the composition and/or number of segments may change and the pad percentage allowed for a particular account holder may change over time. Thus, an account holder's credit limit may remain constant during a time period, but the account holder may be allowed different credit limit extensions (or limitations) at different points during the time period, thereby temporarily increasing (or decreasing when a credit limit limitation is created) the usable percentage of the credit limit. Segmentation of a group of account holders may occur periodically, thereby potentially resulting in different pad percentages for account holders each time the steps 102 and 104 are completed for the group of account holders.

In some embodiments, the step 104 may result in eight different sets of possible credit limit pads for the three segments A, B, C, as illustrated in Table 2.

TABLE 2

| Account Holder | Account Holder | Account Holder |
|---|---|---|
| Segment A | Segment B | Segment C |
| Allowable Credit | Allowable Credit | Allowable Credit |
| Limit Pad | Limit Pad | Limit Pad |
| Percentage | Percentage | Percentage |
| 101% | 102% | 105% |
| 101% | 102% | 115% |
| 101% | 104% | 105% |
| 101% | 104% | 115% |
| 105% | 102% | 105% |
| 105% | 102% | 115% |
| 105% | 104% | 105% |
| 105% | 104% | 115% |

As illustrated in the example of Table 2, segment A may have either a credit limit extension of one percent or five percent, thereby creating a pad percentage of 101% or 105%. Similarly, segment B may have either a credit limit extension of two percent or four percent, thereby creating a pad percentage of 102% or 104%. Likewise, segment C may have either a credit limit extension of five percent or fifteen percent, thereby creating a pad percentage of 105% or 115%.

The selection of which group of allowable credit limit extensions to use may depend on business goals or criteria. For example, a business may want to vary the credit limit extensions for different segments of account holders such that business' overall sales improve while the bad amounts associated with the sales do not increase by more than five percent. As another example, the business may want to increase overall sales while not allowing a credit limit extension of more than ten percent.

As a more specific example, each of the eight possible sets of credit limit extensions illustrated in Table 2 may result in different amounts of sales increases and bad amount. The set that allows a 101% pad percentage for segment A, a 102% pad percentage for segment B, and a 105% pad percentage for segment C may increase sales by account holders in the segments A, B, C by $60,000 and bad sales by $1,500. Alternatively, the set that allows a 101% pad percentage for segment A, a 102% pad percentage for segment B, and a 115% pad percentage for segment C may increase sales by account holders in the segments A, B, C by $70,000 and bad sales by $2,800. Thus, the second set provides a higher amount (e.g., $10,000) of increased sales than the first set, but it also has a higher percentage of bad sales relative to increased sales.

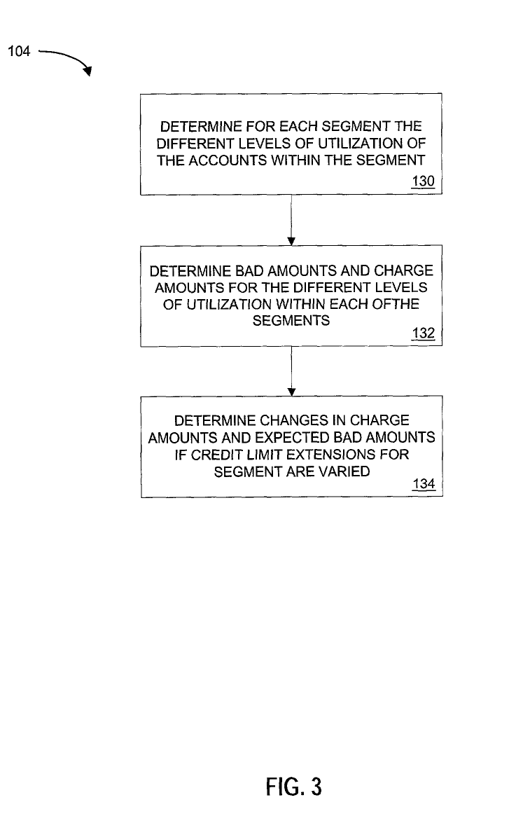

There are many possible ways to conduct the step 104 or otherwise create potential sets of allowable credit limit extensions for a group of different segments. One such implementation of the step 104 is illustrated in FIG. 3.

As illustrated in FIG. 3, the step 104 may include a step 130 during which levels of utilization of accounts are identified or otherwise determined for previous authorization decisions, as illustrated in Table 3 and Table 4 below. In addition, the step 104 may include a step 132 during which bad amounts and charge or sale amounts are determined for the different levels of utilization, as also illustrated in Table 3 and Table 4 below. As will be discussed in more detail below, Table 3 provides information for previously authorized transactions for accounts while Table 4 provides information for previously denied transactions for the accounts.

TABLE 3

| Previously | | | Total | Total | | Total Bad |
|---|---|---|---|---|---|---|
| Approved | Account | | Number | Charge | Bad Number | Amount for |
| Authorization | Holder | Utilization | Of | Amount for | of | Bad |
| Decisions | Segment | Percentage | Transactions | Transactions | Transactions | Transactions |
| Approve | A | 80% | 1 | $159.42 | 0 | 0 |
| Approve | A | 81% | 1 | $505.45 | 0 | 0 |
| Approve | A | 82% | 4 | $901.24 | 1 | $395.66 |
| Approve | A | 83% | 3 | $464.38 | 0 | 0 |
| Approve | A | 88% | 1 | $215.85 | 0 | 0 |
| Approve | A | 89% | 1 | $6,667.95 | 0 | 0 |
| Approve | A | 90% | 1 | $771.39 | 0 | 0 |
| Approve | A | 96% | 2 | $107.84 | 2 | $107.84 |
| Approve | A | 97% | 1 | $71.88 | 1 | $71.88 |
| Approve | A | 98% | 2 | $169.84 | 2 | $169.84 |
| Approve | A | 99% | 1 | $43.70 | 1 | $43.70 |
| Approve | B | 79% | 1 | $146.37 | 0 | 0 |
| Approve | B | 81% | 1 | $237.43 | 0 | 0 |
| Approve | B | 82% | 2 | $195.23 | 1 | $84.93 |
| Approve | B | 83% | 2 | $106.62 | 1 | $56.23 |
| Approve | B | 84% | 1 | $179.87 | 1 | $179.87 |
| Approve | B | 85% | 2 | $399.48 | 2 | $399.48 |
| Approve | B | 87% | 1 | $119.59 | 0 | 0 |
| Approve | B | 88% | 2 | $193.40 | 1 | $106.18 |
| Approve | B | 89% | 2 | $825.78 | 2 | $825.78 |
| Approve | B | 90% | 1 | $218.12 | 0 | 0 |
| Approve | B | 91% | 6 | $1,632.02 | 3 | $318.22 |
| Approve | B | 92% | 3 | $369.49 | 2 | $271.85 |
| Approve | B | 94% | 1 | $44.83 | 0 | 0 |
| Approve | B | 95% | 2 | $330.71 | 0 | 0 |
| Approve | B | 96% | 5 | $693.14 | 4 | $644.10 |
| Approve | B | 97% | 4 | $268.14 | 3 | $146.26 |
| Approve | B | 98% | 4 | $452.28 | 1 | $58.23 |
| Approve | B | 99% | 5 | $1,136.16 | 3 | $356.23 |
| Approve | C | 0% | 9 | $428.01 | 4 | $230.80 |
| Approve | C | 1% | 1 | $30.00 | 1 | $30.00 |
| Approve | C | 2% | 2 | $105.00 | 1 | $45.00 |
| Approve | C | 3% | 2 | $194.78 | 0 | 0 |
| Approve | C | 11% | 1 | $113.12 | 0 | 0 |
| Approve | C | 80% | 1 | $30.00 | 1 | $30.00 |
| Approve | C | 81% | 1 | $45.00 | 0 | 0 |
| Approve | C | 84% | 2 | $173.98 | 0 | 0 |
| Approve | C | 88% | 1 | $226.88 | 0 | 0 |
| Approve | C | 96% | 1 | $60.00 | 0 | 0 |
| Approve | C | 97% | 1 | $45.00 | 0 | 0 |
| Approve | C | 98% | 1 | $13.78 | 0 | 0 |
| Approve | C | 100% | 8 | $2,980.84 | 1 | $45.00 |
| Approve | C | 101% | 22 | $13,136.11 | 1 | $377.82 |
| Approve | C | 102% | 31 | $19,904.64 | 3 | $2,646.37 |
| Approve | C | 103% | 28 | $21,358.66 | 1 | $30.00 |
| Approve | C | 104% | 18 | $15661.52 | 3 | $707.40 |
| Approve | C | 105% | 16 | $7,860.78 | 3 | $2,177.25 |
| Approve | C | 106% | 8 | $4,427.65 | 3 | $1,102.70 |
| Approve | C | 107% | 12 | $7,303.21 | 0 | 0 |
| Approve | C | 108% | 21 | $20,861.18 | 0 | 0 |
| Approve | C | 109% | 13 | $8,567.97 | 1 | $155.22 |
| Approve | C | 110% | 16 | $17,859.48 | 1 | $222.44 |
| Approve | C | 111% | 10 | $16,276.06 | 0 | 0 |
| Approve | C | 112% | 11 | $7,691.99 | 2 | $285.55 |
| Approve | C | 113% | 14 | $15,782.78 | 1 | $2,284.90 |
| Approve | C | 114% | 7 | $5,216.82 | 1 | $171.87 |
| Approve | C | 115% | 8 | $5,992.60 | 0 | 0 |
| Approve | C | 116% | 8 | $4,624.28 | 0 | 0 |
| Approve | C | 117% | 8 | $4,721.77 | 0 | 0 |
| Approve | C | 118% | 5 | $8,516.68 | 0 | 0 |
| Approve | C | 119% | 6 | $2,068.46 | 0 | 0 |
| Approve | C | 120% | 2 | $3,057.58 | 0 | 0 |
| Approve | C | 121% | 10 | $7,216.16 | 1 | $168.80 |
| Approve | C | 122% | 5 | $1,465.76 | 1 | $453.34 |
| Approve | C | 123% | 7 | $15,580.47 | 1 | $366.04 |
| Approve | C | 124% | 3 | $661.57 | 0 | 0 |
| Approve | C | 125% | 4 | $5,608.16 | 0 | 0 |
| Approve | C | 126% | 4 | $5,131.74 | 1 | $106.87 |
| Approve | C | 127% | 5 | $2,524.00 | 1 | $84.37 |
| Approve | C | 128% | 4 | $9,003.00 | 0 | 0 |
| Approve | C | 129% | 8 | $7,848.05 | 4 | $4,013.29 |
| Approve | C | 130% | 3 | $597.03 | 0 | 0 |
| Approve | C | 131% | 2 | $2,778.19 | 0 | 0 |
| Approve | C | 132% | 4 | $4,009.87 | 0 | 0 |
| Approve | C | 133% | 3 | $1,529.18 | 0 | 0 |
| Approve | C | 134% | 1 | $5,306.61 | 0 | 0 |
| Approve | C | 135% | 4 | $4,817.08 | 0 | 0 |
| Approve | C | 136% | 3 | $2,695.41 | 0 | 0 |
| Approve | C | 137% | 5 | $14,100.68 | 0 | 0 |
| Approve | C | 138% | 4 | $3,748.78 | 0 | 0 |
| Approve | C | 139% | 3 | $3,138.70 | 0 | 0 |
| Approve | C | 140% | 2 | $159.85 | 0 | 0 |
| Approve | C | 141% | 5 | $2,315.28 | 0 | 0 |
| Approve | C | 142% | 1 | $125.15 | 0 | 0 |
| Approve | C | 143% | 2 | $2,645.49 | 0 | 0 |
| Approve | C | 144% | 1 | $3645.27 | 0 | 0 |
| Approve | C | 145% | 2 | $4,077.70 | 1 | $934.73 |
| Approve | C | 146% | 1 | $939.29 | 0 | 0 |
| Approve | C | 147% | 1 | $2,535.43 | 0 | 0 |
| Approve | C | 148% | 1 | $46.81 | 1 | $46.81 |
| Approve | C | 149% | 1 | $381.55 | 0 | 0 |
| Approve | C | 151% | 2 | $2,529.30 | 0 | 0 |
| Approve | C | 152% | 1 | $2,729.88 | 0 | 0 |
| Approve | C | 155% | 2 | $1,717.87 | 0 | 0 |
| Approve | C | 156% | 1 | $1,715.59 | 0 | 0 |
| Approve | C | 157% | 1 | $96.89 | 0 | 0 |
| Approve | C | 158% | 1 | $1,000.00 | 0 | 0 |

TABLE 4

| | | | | Total | | Expected |
|---|---|---|---|---|---|---|
| Previously | | | | of Attempted | | Total Bad |
| Denied | Account | | Total | Charge | Bad Number | Amount for |
| Authorization | Holder | Utilization | Number | Amount for | of | Bad |
| Decisions | Segment | Percentage | Transactions | Transactions | Accounts | Accounts |
| Deny | A | 100% | 29 | $10,938.26 | 12 | $1,324.25 |
| Deny | A | 101% | 45 | $11,050.51 | 14 | $1,451.16 |
| Deny | A | 102% | 74 | $45,071.20 | 11 | $6,038.37 |
| Deny | A | 103% | 36 | $21,801.88 | 8 | $1,340.86 |
| Deny | A | 104% | 48 | $13,545.99 | 6 | $1,525.38 |
| Deny | A | 105% | 25 | $14,652.92 | 5 | $2,795.28 |
| Deny | A | 106% | 21 | $7,229.98 | 3 | $529.95 |
| Deny | A | 107% | 26 | $17,772.11 | 5 | $3,531.71 |
| Deny | A | 108% | 19 | $9,607.31 | 5 | $2,028.83 |
| Deny | A | 109% | 20 | $11,768.59 | 4 | $4,417.36 |
| Deny | A | 110% | 7 | $7,592.73 | 1 | $1,099.17 |
| Deny | A | 111% | 9 | $6,148.22 | 1 | $2,845.97 |
| Deny | A | 112% | 17 | $11,733.94 | 2 | $63.00 |
| Deny | A | 113% | 6 | $10,918.06 | 0 | 0 |
| Deny | A | 114% | 7 | $8,003.53 | 0 | 0 |
| Deny | A | 115% | 3 | $4,153.81 | 1 | $853.81 |
| Deny | A | 116% | 8 | $2,994.11 | 2 | $609.69 |
| Deny | A | 117% | 5 | $5,000.25 | 2 | $1,296.10 |
| Deny | A | 118% | 5 | $2,408.67 | 0 | 0 |
| Deny | A | 119% | 7 | $11,760.13 | 0 | 0 |
| Deny | A | 120% | 5 | $4,671.40 | 2 | $3,455.94 |
| Deny | A | 121% | 9 | $15,122.24 | 0 | 0 |
| Deny | A | 122% | 2 | $5,243.72 | 0 | 0 |
| Deny | A | 123% | 1 | $311.69 | 0 | 0 |
| Deny | A | 124% | 4 | $13,203.84 | 0 | 0 |
| Deny | A | 126% | 2 | $3,936.28 | 2 | $3,936.28 |
| Deny | A | 128% | 1 | $560.85 | 0 | 0 |
| Deny | A | 129% | 1 | $3,441.28 | 0 | 0 |
| Deny | A | 130% | 5 | $3,007.72 | 3 | $1,049.22 |
| Deny | A | 132% | 2 | $2,964.59 | 0 | 0 |
| Deny | A | 133% | 1 | $1,871.40 | 0 | 0 |
| Deny | A | 134% | 2 | $12,128.95 | 0 | 0 |
| Deny | A | 136% | 1 | $3,366.29 | 0 | 0 |
| Deny | A | 138% | 5 | $3,722.55 | 5 | $3,722.55 |
| Deny | A | 139% | 2 | $4,130.02 | 0 | 0 |
| Deny | A | 141% | 2 | $823.28 | 0 | 0 |
| Deny | A | 142% | 1 | $425.11 | 0 | 0 |
| Deny | A | 147% | 7 | $13,257.14 | 0 | 0 |
| Deny | A | 148% | 3 | $5,358.17 | 0 | 0 |
| Deny | A | 149% | 5 | $7,116.47 | 3 | $1,944.15 |
| Deny | A | 150% | 2 | $8,851.71 | 0 | 0 |
| Deny | A | 151% | 1 | $2,024.32 | 0 | 0 |
| Deny | A | 156% | 2 | $2,935.38 | 0 | 0 |
| Deny | A | 158% | 1 | $2,380.39 | 0 | 0 |
| Deny | A | 173% | 1 | $1,500.00 | 1 | $1,500.00 |
| Deny | A | 180% | 1 | $1,637.36 | 1 | $1,637.36 |
| Deny | A | 185% | 2 | $19,970.42 | 0 | 0 |
| Deny | A | 187% | 1 | $1,300.00 | 0 | 0 |
| Deny | A | 191% | 1 | $6,680.36 | 0 | 0 |
| Deny | A | 198% | 1 | $2,000.00 | 0 | 0 |
| Deny | A | 200% | 1 | $1,500.00 | 0 | 0 |
| Deny | A | 201% | 2 | $12,204.85 | 0 | 0 |
| Deny | B | 100% | 79 | $19,094.30 | 19 | $4,245.69 |
| Deny | B | 101% | 100 | $21,456.02 | 32 | $5,199.34 |
| Deny | B | 102% | 74 | $22,517.84 | 17 | $6,179.13 |
| Deny | B | 103% | 55 | $19,942.92 | 16 | $5,757.58 |
| Deny | B | 104% | 46 | $19,313.28 | 9 | $1,964.73 |
| Deny | B | 105% | 34 | $13,872.50 | 6 | $2,488.79 |
| Deny | B | 106% | 23 | $5,612.53 | 1 | $60.00 |
| Deny | B | 107% | 34 | $16,156.57 | 7 | $1,124.15 |
| Deny | B | 108% | 14 | $6,260.31 | 6 | $3,386.47 |
| Deny | B | 109% | 28 | $16,747.53 | 1 | $97.74 |
| Deny | B | 110% | 15 | $11,854.00 | 5 | $2,745.23 |
| Deny | B | 111% | 10 | $8,482.27 | 0 | 0 |
| Deny | B | 112% | 22 | $10,236.58 | 3 | $263.54 |
| Deny | B | 113% | 17 | $15,801.79 | 3 | $7,422.65 |
| Deny | B | 114% | 9 | $5,025.26 | 0 | 0 |
| Deny | B | 115% | 7 | $2,861.73 | 0 | 0 |
| Deny | B | 116% | 6 | $1,674.81 | 0 | 0 |
| Deny | B | 117% | 6 | $4,511.51 | 2 | $907.54 |
| Deny | B | 118% | 5 | $2,388.19 | 0 | 0 |
| Deny | B | 119% | 3 | $1,231.29 | 1 | $157.61 |
| Deny | B | 120% | 4 | $5,891.70 | 0 | 0 |
| Deny | B | 121% | 7 | $8,919.31 | 1 | $259.16 |
| Deny | B | 122% | 2 | $3,664.02 | 0 | 0 |
| Deny | B | 123% | 2 | $552.34 | 0 | 0 |
| Deny | B | 124% | 1 | $264.34 | 0 | 0 |
| Deny | B | 125% | 3 | $3,991.40 | 0 | 0 |
| Deny | B | 126% | 6 | $3,914.61 | 0 | 0 |
| Deny | B | 127% | 1 | $504.03 | 1 | $504.03 |
| Deny | B | 128% | 1 | $289.79 | 0 | 0 |
| Deny | B | 129% | 3 | $3,469.88 | 0 | 0 |
| Deny | B | 130% | 3 | $919.89 | 0 | 0 |
| Deny | B | 132% | 5 | $8,063.65 | 1 | $328.60 |
| Deny | B | 134% | 3 | $9,440.77 | 1 | $758.40 |
| Deny | B | 135% | 2 | $10,000.00 | 0 | 0 |
| Deny | B | 137% | 2 | $1,796.30 | 0 | 0 |
| Deny | B | 138% | 1 | $84.75 | 0 | 0 |
| Deny | B | 139% | 1 | $2,786.21 | 0 | 0 |
| Deny | B | 141% | 4 | $573.38 | 1 | $360.83 |
| Deny | B | 147% | 1 | $1,181.56 | 0 | 0 |
| Deny | B | 149% | 2 | $236.92 | 0 | 0 |
| Deny | B | 150% | 1 | $1,217.72 | 0 | 0 |
| Deny | B | 154% | 1 | $4,508.48 | 1 | $4,508.48 |
| Deny | B | 155% | 1 | $699.84 | 0 | 0 |
| Deny | B | 156% | 1 | $8,247.78 | 0 | 0 |
| Deny | B | 157% | 1 | $8,443.29 | 0 | 0 |
| Deny | B | 162% | 2 | $2,792.47 | 1 | $1,276.21 |
| Deny | B | 169% | 3 | $2,462.82 | 0 | 0 |
| Deny | B | 180% | 3 | $3,139.08 | 0 | 0 |
| Deny | B | 188% | 2 | $6,658.08 | 0 | 0 |
| Deny | B | 201% | 4 | $8,838.44 | 0 | 0 |
| Deny | C | 100% | 46 | $38,961.50 | 8 | $2,001.10 |
| Deny | C | 101% | 77 | $29,217.10 | 8 | $3,503.37 |
| Deny | C | 102% | 67 | $45,637.33 | 4 | $2,148.22 |
| Deny | C | 103% | 45 | $17,859.94 | 4 | $773.35 |
| Deny | C | 104% | 45 | $41,693.38 | 6 | $2,964.22 |
| Deny | C | 105% | 34 | $17,168.41 | 0 | 0 |
| Deny | C | 106% | 33 | $31,595.75 | 1 | $199.92 |
| Deny | C | 107% | 26 | $29,030.08 | 1 | $1,051.80 |
| Deny | C | 108% | 28 | $16,548.57 | 1 | $202.94 |
| Deny | C | 109% | 19 | $31,161.32 | 0 | 0 |
| Deny | C | 110% | 22 | $25,740.19 | 3 | $2590.36 |
| Deny | C | 111% | 18 | $14,416.72 | 0 | 0 |
| Deny | C | 112% | 13 | $9,730.07 | 0 | 0 |
| Deny | C | 113% | 10 | $22,205.13 | 1 | $32.32 |
| Deny | C | 114% | 22 | $22,025.90 | 1 | $334.51 |
| Deny | C | 115% | 9 | $3,420.27 | 0 | 0 |
| Deny | C | 116% | 14 | $18,431.66 | 0 | 0 |
| Deny | C | 117% | 10 | $20,592.96 | 1 | $90.00 |
| Deny | C | 118% | 8 | $17,301.67 | 0 | 0 |
| Deny | C | 119% | 8 | $8,657.99 | 0 | 0 |
| Deny | C | 120% | 5 | $3,835.30 | 0 | 0 |
| Deny | C | 121% | 7 | $9,854.10 | 0 | 0 |
| Deny | C | 122% | 8 | $12,281.54 | 0 | 0 |
| Deny | C | 123% | 5 | $7,637.84 | 0 | 0 |
| Deny | C | 124% | 6 | $9,610.03 | 0 | 0 |
| Deny | C | 125% | 4 | $3,285.94 | 0 | 0 |
| Deny | C | 126% | 9 | $3,426.55 | 0 | 0 |
| Deny | C | 127% | 1 | $4,645.07 | 0 | 0 |
| Deny | C | 128% | 7 | $16,440.33 | 0 | 0 |
| Deny | C | 129% | 3 | $10,777.39 | 0 | 0 |
| Deny | C | 130% | 2 | $4,681.94 | 0 | 0 |
| Deny | C | 131% | 4 | $4,518.27 | 0 | 0 |
| Deny | C | 132% | 4 | $5,476.20 | 0 | 0 |
| Deny | C | 133% | 1 | $418.89 | 0 | 0 |
| Deny | C | 134% | 1 | $4,500.00 | 0 | 0 |
| Deny | C | 136% | 4 | $7,969.12 | 0 | 0 |
| Deny | C | 137% | 1 | $4,669.33 | 0 | 0 |
| Deny | C | 138% | 1 | $1,000.00 | 0 | 0 |
| Deny | C | 139% | 3 | $3,243.61 | 0 | 0 |
| Deny | C | 140% | 2 | $7,541.55 | 0 | 0 |
| Deny | C | 141% | 3 | $5,689.66 | 0 | 0 |
| Deny | C | 142% | 3 | $6,679.04 | 0 | 0 |
| Deny | C | 143% | 3 | $4,995.23 | 0 | 0 |
| Deny | C | 144% | 5 | $9,732.05 | 0 | 0 |
| Deny | C | 145% | 2 | $4,250.13 | 0 | 0 |
| Deny | C | 146% | 4 | $4,653.81 | 0 | 0 |
| Deny | C | 147% | 1 | $1,266.25 | 0 | 0 |
| Deny | C | 148% | 3 | $4,239.76 | 1 | $773.78 |
| Deny | C | 150% | 1 | $2,500.00 | 0 | 0 |
| Deny | C | 151% | 1 | $2,742.65 | 0 | 0 |
| Deny | C | 152% | 5 | $6,678.48 | 0 | 0 |
| Deny | C | 153% | 2 | $2,939.88 | 0 | 0 |
| Deny | C | 156% | 2 | $5,672.69 | 0 | 0 |
| Deny | C | 158% | 1 | $600.00 | 0 | 0 |
| Deny | C | 159% | 1 | $1,869.64 | 0 | 0 |
| Deny | C | 161% | 3 | $3,941.31 | 2 | $3,267.18 |
| Deny | C | 162% | 2 | $3,626.47 | 0 | 0 |
| Deny | C | 164% | 2 | $3,407.36 | 0 | 0 |
| Deny | C | 173% | 4 | $8,430.27 | 0 | 0 |
| Deny | C | 178% | 2 | $3,202.64 | 0 | 0 |
| Deny | C | 179% | 2 | $9,630.70 | 0 | 0 |
| Deny | C | 180% | 1 | $4,000.00 | 0 | 0 |
| Deny | C | 183% | 1 | $6,280.56 | 0 | 0 |
| Deny | C | 184% | 1 | $6,331.74 | 0 | 0 |
| Deny | C | 185% | 2 | $4,592.38 | 0 | 0 |
| Deny | C | 189% | 1 | $2,619.47 | 0 | 0 |
| Deny | C | 193% | 1 | $4,691.66 | 0 | 0 |
| Deny | C | 194% | 4 | $16,313.42 | 0 | 0 |
| Deny | C | 200% | 1 | $4,958.48 | 0 | 0 |
| Deny | C | 201% | 11 | $25,267.90 | 0 | 0 |

Table 3 reflects previous authorization decisions that were approved for account holders in different segments. For example, as illustrated in Table 3, there was a previous authorization decision made for a transaction in segment A involving an account that was eighty percent utilized at the time the transaction authorization was requested. Utilization of an account during a transaction can be calculated as the current balance of the account at the time of the transaction plus the amount sought to be purchased during the transaction (even if the transaction is denied), divided by the current credit limit of the account. The transaction involved an amount of $159.42, none of which was bad during the twelve month time period after the transaction. As another example, as illustrated in Table 3, there were four transactions for segment A that involved for a total of $901.24 and up to four accounts that were eighty-one percent utilized as a result of the transactions. Of the accounts involved in the four authorized transactions, one account resulted in a bad amount of $395.66 during the twelve-month period following the transaction.

As segment A does not have any listings for previously authorized transactions for accounts that were less than eighty percent utilized or more than ninety-nine percent utilized as a result of the transaction(s), it can be assumed that no such transactions exist for the time period of transactions used to create Table 3.

Table 4 reflects previous authorization decisions that were denied for account holders in different segments. For example, segment A includes account holders involved in twenty-nine denied transactions during which utilization of each of the accounts at the time of the transaction was one hundred percent. The twenty-nine denied transactions involved amounts totaling $10,938.26. Of the accounts involved in the twenty-nine transactions, twelve accounts generated bad amounts. Thus, if all of the twenty-nine transactions totaling $10,938.26 had been approved, it is expected that $1,324.25 would have gone bad. That is, of the twenty-nine denied transactions, the transactions associated with the twelve accounts that had bad amounts involved a total of $1,324.25. The $1,324.25 amount reflects the portion of the denied $10,938.26 amount that is expected to have gone bad since the $1,324.25 amount is associated with the twelve accounts that had bad amounts. In this case, since the twelve accounts that had bad amounts attempted to charge $1,324.25 but were denied, it is not known if the full $1,324.25 would actually have been bad. However, for purposes of the present invention, it is assumed (although not required) that the full amounts attempted to be charged by accounts that later went bad would have gone bad if the transactions involving the accounts had been authorized instead of denied.

As illustrated in both Tables 3 and 4, some account holders were involved in approved transactions during which credit limit extensions were allowed and some account holders where involved in denied transactions during which credit limit extensions were not allowed. Based on this historical data, different sets of allowable credit limit extensions and expected results for each segment A, B, C of account holders can be generated during a step 134.

There are many ways in which the step 134 might be implemented. However, one such implementation may, for each utilization level in Table 3, determine what might have been the result if approved transactions associated with the utilization levels had not been approved. In addition, the implementation may, for each utilization level in Table 4, determine an expected result if the denied transactions had been allowed for the utilization level.

As illustrated in Table 3, segment A includes one previous authorization decision for a transaction that placed the account at a ninety-nine percent utilization level. The total amount charged for the transaction was $43.70, all of which later become bad. Thus, if the transaction had not been authorized, there would have been $43.70 less in sales and $43.70 less in bad amounts.

As another example, if the previously approved transactions at the ninety-eight and ninety-nine percent utilization levels for segment A had been denied instead of approved, there would have been $213.54 (i.e., $169.84+$43.70) less in sales and $213.54 (i.e., $169.84+$43.70) less in bad amounts. As a further example, if the previously approved transactions at the eighty-nine through ninety-nine percent utilization levels for segment A had been denied instead of approved, there would have been $7,832.60 (i.e., $6,667.95+$771.39+$107.84+71.88+$169.84+$43.70) less in sales and $393.26 (i.e., $107.84+$71.88+$169.84+$43.70) less in bad amounts. As shown in Table 4, segment A does not include any utilization levels greater than one hundred percent. Thus, none of the account holders in segment A were authorized to conduct transactions that would have required credit limit extensions during the time period used to generate Table 3.

In a similar manner for determinations for approved transactions associated with account holders in segment A as described above, determinations are made for approved transactions associated with account holders in segments B and C.

As neither of the example A or B segments illustrated in Table 4 include utilizations greater than one hundred percent, analysis of segment C account holders may provide the most useful information since account holders in segment C conducted authorized transactions that used or had credit limit extensions. For example, if the previously approved transactions at the 149%-158% utilization levels for segment C had been denied instead of approved, there would have been $10,171.08 (i.e., $381.55+$2,529.30+$2,729.88+$1,717.87+$1,715.59+$96.89+$1000.00) less in sales but no decrease in bad amounts. As another example, if the previously approved transactions at the 145%-158% utilization levels for segment C had been denied instead of approved, there would have been $17,770.31 (i.e., $4,077.70+$939.29+$2,535.43+$46.81+$381.55+$2,529.30+$2,729.88+$1,717.87+$1,715.59+$96.89+$1000.00) less in sales and $981.54 (i.e. 934.73+$46.81) less in bad amounts.

In addition to analyzing the approved transactions indicated in Table 3. Analysis also may be performed on the transactions that were denied as indicated in Table 4. For example, segment A had twenty-nine transactions denied at the one hundred percent utilization level. If all of the denied transactions for accounts in segment A were allowed a one hundred percent pad (i.e., a zero credit limit extension) and approved instead of denied, there would have been $10,938.26 in increased sales and an expected bad amount of $1,324.25 since all of the twenty-nine transactions in the segment A one hundred percent utilization level had been allowed instead of denied.

If all of the denied transactions for accounts in segment A were allowed a one hundred percent pad, there would have been an increased sales amount of $21,987.77 (i.e., $10,938.26+$11,050.51) and an expected bad amount of $2,775.41 (i.e., $1,324.25+$1,451.16) since the twenty-nine denied transactions for the one hundred percent utilization level for segment A and the forty-five denied transactions for the one hundred and one percent utilization level for segment A would be allowed.

Continuing on, if all of the denied transactions for accounts in segment A were allowed a one hundred and two percent pad, there would have been an increased sales amount of $67,058.97 (i.e., $10,938.26+$11,050.51+$45,071.20) and an expected bad amount of $8,813.78 (i.e., $1,324.25+$1,451.16+$6,038.37) since the twenty-nine denied transactions for the one hundred percent utilization level for segment A, the forty-five denied transactions for the one hundred and one percent utilization level for segment A, and the seventy-four denied transactions for the one hundred and two percent utilization level for segment A would be allowed instead of denied.

The process described above continues until each possible pad percentage is computed for the denied transactions associated with account holders in segment A. As illustrated in Table 4, the highest pad percentage needed to allow all of the transactions for account holders in segment A to be approved is 201%.

In a similar manner for determinations for denied transactions associated with account holders in segment A as described above, determinations are made for denied transactions associated with account holders in segment B. For example, if all of the denied transactions for accounts in segment B were allowed a one hundred percent pad (i.e., all of the seventy-nine transactions in the segment B one hundred percent utilization level had been allowed instead of denied), there would have been $19,094.30 in increased sales and an expected bad amount of $4,245.69. If all of the denied transactions for accounts in segment B were allowed a one hundred and one percent pad, there would have been an increased sales amount of $40,550.32 (i.e., $19,094.30+$21,456.02) and an expected bad amount of $9,445.03 (i.e., $4,245.69+$5,199.34) since the seventy-nine denied transactions for the one hundred percent utilization level for segment B and the one hundred denied transactions for the one hundred and one percent utilization level for segment B would be allowed. As illustrated in Table 4, the highest pad percentage needed to allow all of the transactions for account holders in segment B to be approved is 201%.

In a similar manner for determinations for denied transactions associated with account holders in segments A and B as described above, determinations are made for denied transactions associated with account holders in segment C. For example, if all of the denied transactions for accounts in segment C were allowed a one hundred percent pad (i.e., all of the forty-six transactions in the segment C one hundred percent utilization level had been allowed instead of denied), there would have been $38,961.50 in increased sales and an expected bad amount of $2,001,10. If all of the denied transactions for accounts in segment C were allowed a one hundred and one percent pad, there would have been an increased sales amount of $68,178.60 (i.e., $38,961.50+$229,217.10) and an expected bad amount of $5,504.47 (i.e., $2,001.10+$3,503.37) since the forty-six denied transactions for the one hundred percent utilization level for segment C and the seventy-seven denied transactions for the one hundred and one percent utilization level for segment C would be allowed.

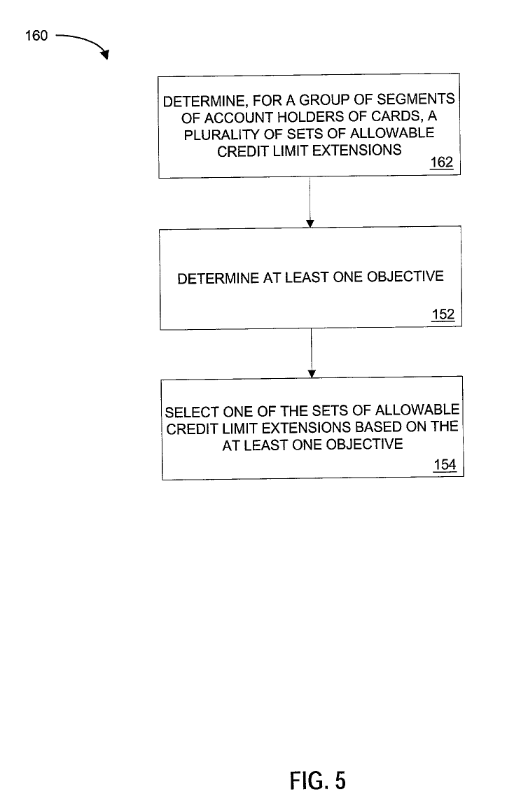

When possible variations for the different individual segments A, B, C are determined, different combinations or sets of the pad percentages for the different segments A, B, C can be created, as illustrated in FIG. 5. For example, different sets assume that different pad percentages are allowed for each segment. Based on the data for the segments A, B, C in Table 3 and Table 4, different sets of pad percentages will produce different expected total sales and expected bad amounts. For purposes of this example, Table 5 assumes that account holders in the three segments A, B, C previously generated total sales of $357,386.00 and bad sales or bad amounts of $20,953 at their current pad percentages during a one month time period. Also, note that Table 5 does not indicate all of the possible combinations of the credit limit extensions or pad percentages for the different segments A, B, C of account holders.

TABLE 5

| | | | | | | Expected |
|---|---|---|---|---|---|---|
| Account | Account | Account | Expected | Expected | Expected | Bad Sales |
| Holder | Holder | Holder | Total Sales | Bad Sales | Sales Kept | Kept |
| Segment A | Segment B | Segment C | For Set of | For Set of | Percentage | Percentage |
| Pad | Pad | Pad | Pad | Pad | Relative to | (Relative to |
| Percentage | Percentage | Percentage | Percentages | Percentages | $357,386.00) | $20,953.00) |
| 111% | 100% | 100% | $190,125 | $30,654 | 53.20% | 146.30% |
| 110% | 100% | 100% | $182,532 | $29,555 | 51.07% | 141.06% |
| 109% | 100% | 102% | $255,059 | $31,065 | 71.37% | 148.26% |
| 109% | 100% | 101% | $212,706 | $27,184 | 59.52% | 129.74% |
| 108% | 101% | 101% | $222,193 | $29,401 | 62.17% | 140.32% |
| 108% | 101% | 100% | $180,250 | $27,355 | 50.44% | 130.55% |
| 108% | 100% | 102% | $245,452 | $29,036 | 68.68% | 138.58% |
| 108% | 100% | 101% | $203,098 | $25,155 | 56.83% | 120.06% |
| 107% | 102% | 101% | $225,877 | $31,068 | 63.20% | 148.28% |
| 107% | 102% | 100% | $183,934 | $29,022 | 51.47% | 138.51% |
| 107% | 101% | 102% | $246,774 | $29,750 | 69.05% | 141.99% |
| 107% | 101% | 101% | $204,421 | $25,869 | 57.20% | 123.46% |
| 107% | 100% | 104% | $332,440 | $31,103 | 93.02% | 148.44% |
| 107% | 100% | 103% | $293,221 | $30,299 | 82.05% | 144.61% |
| 107% | 100% | 102% | $227,679 | $25,505 | 63.71% | 121.72% |
| 107% | 100% | 101% | $185,326 | $21,623 | 51.86% | 103.20% |
| 106% | 102% | 101% | $218,647 | $30,539 | 61.18% | 145.75% |
| 106% | 101% | 102% | $239,544 | $29,220 | 67.03% | 139.46% |
| 106% | 101% | 101% | $197,191 | $25,339 | 55.18% | 120.93% |
| 106% | 100% | 104% | $325,210 | $30,573 | 91.00% | 145.91% |
| 106% | 100% | 103% | $285,991 | $29,769 | 80.02% | 142.08% |
| 106% | 100% | 102% | $220,449 | $24,975 | 61.68% | 119.19% |
| 105% | 102% | 101% | $203,994 | $27,743 | 57.08% | 132.41% |
| 105% | 101% | 103% | $290,433 | $31,220 | 81.27% | 149.00% |
| 105% | 101% | 102% | $224,891 | $26,425 | 62.93% | 126.12% |
| 105% | 101% | 101% | $182,538 | $22,544 | 51.08% | 107.59% |
| 105% | 100% | 104% | $310,557 | $27,777 | 86.90% | 132.57% |
| 105% | 100% | 103% | $271,339 | $26,974 | 75.92% | 128.74% |
| 105% | 100% | 102% | $205,797 | $22,179 | 57.58% | 105.85% |
| 104% | 102% | 102% | $232,801 | $30,099 | 65.14% | 143.65% |
| 104% | 102% | 101% | $190,448 | $26,218 | 53.29% | 125.13% |
| 104% | 101% | 104% | $316,105 | $30,498 | 88.45% | 145.55% |
| 104% | 101% | 103% | $276,887 | $29,694 | 77.48% | 141.72% |
| 104% | 101% | 102% | $211,345 | $24,900 | 59.14% | 118.84% |
| 104% | 100% | 105% | $354,366 | $29,924 | 99.15% | 142.81% |
| 104% | 100% | 104% | $297,011 | $26,252 | 83.11% | 125.29% |
| 104% | 100% | 103% | $257,793 | $25,449 | 72.13% | 121.46% |
| 104% | 100% | 102% | $192,251 | $20,654 | 53.79% | 98.57% |
| 103% | 102% | 102% | $210,999 | $28,758 | 59.04% | 137.25% |
| 103% | 101% | 102% | $189,543 | $23,559 | 53.04% | 112.44% |
| 103% | 100% | 106% | $357,593 | $30,760 | 100.06% | 146.81% |
| 103% | 100% | 105% | $332,564 | $28,583 | 93.05% | 136.41% |
| 103% | 100% | 104% | $275,209 | $24,911 | 77.01% | 118.89% |
| 103% | 100% | 103% | $235,991 | $24,108 | 66.03% | 115.06% |
| 102% | 103% | 102% | $188,446 | $28,899 | 52.73% | 137.92% |
| 102% | 102% | 104% | $270,688 | $28,318 | 75.74% | 135.15% |
| 102% | 102% | 103% | $231,470 | $27,514 | 64.77% | 131.32% |
| 102% | 101% | 108% | $403,973 | $31,322 | 113.04% | 149.49% |
| 102% | 101% | 107% | $367,640 | $30,270 | 102.87% | 144.47% |
| 102% | 101% | 106% | $331,616 | $28,967 | 92.79% | 138.25% |
| 102% | 101% | 105% | $306,587 | $26,790 | 85.79% | 127.86% |
| 102% | 101% | 104% | $249,232 | $23,118 | 69.74% | 110.34% |
| 102% | 101% | 103% | $210,014 | $22,315 | 58.76% | 106.50% |
| 102% | 100% | 113% | $553,732 | $30,533 | 154.94% | 145.72% |
| 102% | 100% | 110% | $462,018 | $27,434 | 129.28% | 130.93% |
| 102% | 100% | 107% | $348,546 | $26,024 | 97.53% | 124.20% |
| 102% | 100% | 106% | $312,522 | $24,722 | 87.45% | 117.99% |
| 102% | 100% | 105% | $287,493 | $22,544 | 80.44% | 107.60% |
| 102% | 100% | 104% | $230,138 | $18,873 | 64.39% | 90.07% |
| 102% | 100% | 103% | $190,919 | $18,069 | 53.42% | 86.24% |
| 101% | 102% | 105% | $316,993 | $30,538 | 88.70% | 145.75% |
| 101% | 102% | 104% | $259,638 | $26,867 | 72.65% | 128.22% |
| 101% | 102% | 103% | $220,419 | $26,063 | 61.68% | 124.39% |
| 101% | 101% | 110% | $470,062 | $30,229 | 131.53% | 144.27% |
| 101% | 101% | 107% | $356,589 | $28,819 | 99.78% | 137.54% |
| 101% | 101% | 106% | $320,566 | $27,516 | 89.70% | 131.32% |
| 101% | 101% | 105% | $295,537 | $25,339 | 82.69% | 120.93% |
| 101% | 101% | 104% | $238,182 | $21,667 | 66.65% | 103.41% |
| 101% | 101% | 103% | $198,963 | $20,864 | 55.67% | 99.58% |
| 101% | 100% | 114% | $580,670 | $31,399 | 162.48% | 149.85% |
| 101% | 100% | 113% | $542,682 | $29,081 | 151.85% | 138.79% |
| 101% | 100% | 110% | $450,967 | $25,983 | 126.18% | 124.01% |
| 101% | 100% | 107% | $337,495 | $24,573 | 94.43% | 117.28% |
| 101% | 100% | 106% | $301,472 | $23,270 | 84.35% | 111.06% |
| 101% | 100% | 105% | $276,442 | $21,093 | 77.35% | 100%.67% |
| 101% | 100% | 104% | $219,088 | $17,422 | 61.30% | 83.15% |
| 101% | 100% | 103% | $179,869 | $16,618 | 50.33% | 79.31% |
| 100% | 103% | 103% | $231,999 | $30,918 | 64.92% | 147.56% |
| 100% | 102% | 105% | $306,054 | $29,214 | 85.64% | 139.43% |
| 100% | 102% | 104% | $248,700 | $25,542 | 69.59% | 121 .90% |
| 100% | 102% | 103% | $209,481 | $24,739 | 58.61% | 118.07% |
| 100% | 101% | 110% | $459,123 | $28,904 | 128.47% | 137.95% |
| 100% | 101% | 107% | $345,651 | $27,494 | 96.72% | 131.22% |
| 100% | 101% | 106% | $309,628 | $26,192 | 86.64% | 125.00% |
| 100% | 101% | 105% | $284,598 | $24,015 | 79.63% | 114.61% |
| 100% | 101% | 104% | $227,244 | $20,343 | 63.58% | 97.09% |
| 100% | 101% | 103% | $188,025 | $19,540 | 52.61% | 93.26% |
| 100% | 100% | 123% | $729,013 | $31,293 | 203.98% | 149.35% |
| 100% | 100% | 117% | $629,443 | $30,581 | 176.12% | 145.95% |
| 100% | 100% | 113% | $531,744 | $27,757 | 148.79% | 132.47% |
| 100% | 100% | 110% | $440,029 | $24,659 | 123.12% | 117.69% |
| 100% | 100% | 107% | $326,557 | $23,249 | 91.37% | 110.96% |
| 100% | 100% | 106% | $290,533 | $21,946 | 81.29% | 104.74% |
| 100% | 100% | 105% | $265,504 | $19,769 | 74.29% | 94.35% |
| 100% | 100% | 104% | $208,149 | $16,097 | 58.24% | 76.83% |

As illustrated in FIG. 5, different combinations of pad percentages for the different segments A, B, C provide different expected total sales and different expected bad sales or amounts. Since the account holders in the three segments A, B, C previously generated total sales of $357,386.00 and bad sales or bad amounts of $20,953.00 at their current pad percentages, some of the sets of allowable credit limit extensions or pad percentages are expected to produce less that $357,386.00 in sales, more than $20,953.00 in bad sales. For example, setting the pad percentages for segments A, B, C at 111%, 100%, 100%, respectively, is expected to produce only $190,125.00 in total sales, but $30,654.00 in expected bad sales. In contrast, setting the pad percentages for segments A, B, C at 100%, 100%, 123%, respectively, is expected to produce only $729,013.00 in total sales and $31,293.00 in expected bad sales.

Table 5 represents or provides sets of potential allowable credit limit extensions for accounts. In some embodiments, from this list of potential sets, a credit card issuer, merchant or other party or device may select one of the sets to implement. The decision of which set of allowable credit limit extensions may be determined, in whole or in part, by one or more business, financial or other objectives. For example, a credit card issuer may want to maximize of uses of financial accounts by account holders; have a maximum allowable credit limit extension; have a minimum amount of use of financial accounts by account holders; have a maximum amount of losses or bad amounts resulting from use of financial accounts by account holders; have a maximum credit limit extension for an account holder in a segment having a bad rate exceeding a designated amount; have a zero credit limit extension for an account holder in a segment having a bad rate exceeding a designated amount; deny authorization to use a financial account by an account holder in a segment having a bad rate exceeding a designated amount, etc.

As illustrated in Table 5, there can be a large number of different sets of possible allowable credit limit extensions or pad percentages for the different segments A, B, C. In some embodiments, an entity or device implementing the method 100 or viewing the results (e.g., the Table 5) of the method 100 may want to provide some guidelines regarding the sets of possible credit limit extensions that may be considered or generated. For example, a set may be eliminated if any segment within the set has a pad percentage that exceeds a predefined threshold. As another example, potential pad percentage changes may be limited to multiples of designated percentages (e.g., one percent, five percent) such that the range of possible pad percentages for each segment is increased by making the multiplier lower or is decreased by making the multiplier higher. As a further example, a pad percentage for a segment may be eliminated from consideration if it places the expected bad rate for the segment above a designated threshold percentage. Moreover, a set of credit limit extensions for the segments A, B, C may be eliminated from consideration if the overall bad rate for the three segments A, B, C exceeds a designated threshold percentage. In an additional example, a set of possible credit limit extensions for the segments A, B, C may be eliminated from consideration if the minimum sales expected from the set is lower than a designated percentage (e.g., fifty percent) of the expected sales if no change to the current credit limit extensions is made for the segments. Similarly, a set of possible credit limit extensions may be eliminated from consideration if the bad amount expected from the set is higher than a designated percentage (e.g., one hundred and fifty percent) of the expected bad amounts if no change to the current credit limit extensions is made for the segments.

In some embodiments, the step 104 may include determining an allowable credit limit extension for one or more of the segments identified during the step 102 that optimizes or maximizes a desired objective or result for the one or more segments. For example, there may be situations where an optimal pad percentage for the segment A in light of a given objective is 105%. However, the pad percentage for the segment A that provides optimal results for all of the segments A, B, C in light of the objective may be different (e.g., 103%). For example, a pad percentage for a given segment may represent an optimal offset of increased sales and bad sales associated with the segment in light of the given objective. The optimal offset for the group of segments, however, may require a different pad percentage for the segment.

Optimal pad percentages for the individual segments A, B, C of account holders may be used as starting points for variation or adjustment among the three segments. For example, suppose that the best pad percentage for segment A taken individually in light of a designated objective is 105%, the best pad percentage for segment B taken individually in light of the designated objective is 108%, and the best pad percentage for segment C taken individually in light of the designated objective is 110%. The pad percentages for the different segments A, B, C, may be varied relative to the starting pad percentages of 105%, 108%, 110%, respectively to determine if a different allocation of pad percentages for the segments A, B, C will result in better results overall relative to the designated objective. For example, the best results might be obtained overall if the pad percentages for the segments A, B, C are 102%, 109%, 111%, respectively, instead of 105%, 108%, 110%. The starting pad percentages of 105%, 108%, 110% may be varied systematically to check other sets of pad percentages. For example, the pad percentages for the segments A, B, C may be allowed to vary in increments of one percent between three percentage points less and three percentage points more than the optimal individual percentages. Thus, all combinations of pad percentages are checked for the segments A, B, C, wherein segment A is in a range of pad percentages between and including 102%-108%, segment B is in a range between and including 105%-111%, and segment C is in a range between and including 107%-113%. If one percent increments are the minimum allowed, there are 343 combinations for the three segments (e.g., 102% for A, 105% for B, 107% for C; 102% for A, 105% for B, 108% for C; 102% for A, 105% for B, 109% for C; 102% for A, 105% for B, 110% for C; etc.). In some embodiments, other variables or objectives may be used to create even further combinations.

In some embodiments, the method 100 may include selecting one of the sets of allowable credit limit extensions determined during the step 104. In addition, in some embodiments, the method 100 may include authorizing a transactions based on the selected set, providing information regarding one or more of the sets of allowable credit limit extensions determined during the step 104, storing information regarding one or more of the sets of allowable credit limit extensions determined during the step 104, etc.

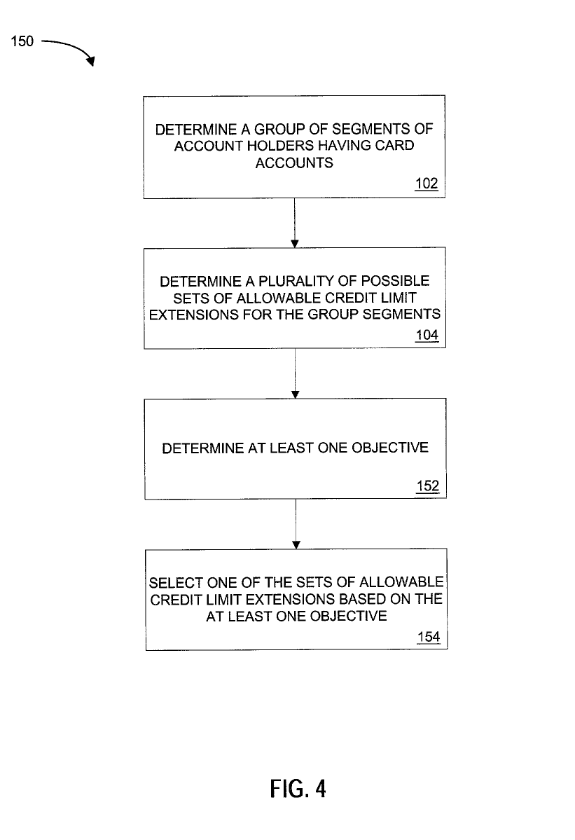

Reference is now made to FIG. 4, where a flow chart 150 is shown which represents the operation of a second embodiment of the present invention. The particular arrangement of elements in the flow chart 150 is not meant to imply a fixed order to the steps; embodiments of the present invention can be practiced in any order that is practicable. In some embodiments, some or all of the steps of the method 150 may be performed or completed by a single entity or device. In some embodiments, the method 140 may include some or all of the variations discussed above with regard to the method 100.

The method 150 includes the steps 102 and 104 previously discussed above. In addition, the method 150 includes a step 152 during which at least one goal or other objective is determined. As previously discussed above, an objective may be or include any type of business, distribution, marketing, financial, customer service, customer acquisition, manufacturing, delivery, packaging or other goal. For example, a credit card issuer or merchant may want to increase overall sales made by account holders via credit cards while keeping bad amounts to a minimum. As another example, the credit card issuer or merchant may want to increase overall sales while setting a maximum credit limit extension that an account holder may receive during a transaction.

During a step 154, one of the sets of allowable credit limit extensions determined during the step 104 is selected based on the objective determined during the step 152. Thus, the method 150 allows for a device or entity to determine multiple sets of possible credit limit extensions for segments of account holders while allowing one of more different business objectives to be taken into account when selecting or identifying the set of credit limit extensions to implement. For example, the sets of possible credit limit extensions in Table 5.

In general, measurement or quantification of the objective(s) determined during the step 152 will be determined relative to the possible credit limit extensions in Table 5 are compared relative to the additional new sales generated as well as the expected bad amounts created. Different credit card issuers or merchants having different business goals may select different sets of credit line extensions from Table 5 depending on their objectives or other attributes of interest or concern.

Reference is now made to FIG. 5, where a flow chart 160 is shown which represents the operation of a third embodiment of the present invention. The particular arrangement of elements in the flow chart 160 is not meant to imply a fixed order to the steps; embodiments of the present invention can be practiced in any order that is practicable. In some embodiments, some or all of the steps of the method 160 may be performed or completed by a single entity or device. The method 160 is particularly useful when the segments of account holders are already known and do not need to be determined. For example, the segments of account holders may be determined by another party, software program or device, etc. In some embodiments, the method 160 may include some or all of the variations discussed above with regard to the methods 100 and 140.

The method 160 includes the steps 152 and 154 previously discussed above. In addition, the method 160 includes a step 162 during which a plurality of groups of credit limit extensions is determined for a group of segments. The step 162, therefore, is similar to the step 104 previously discussed above.

System

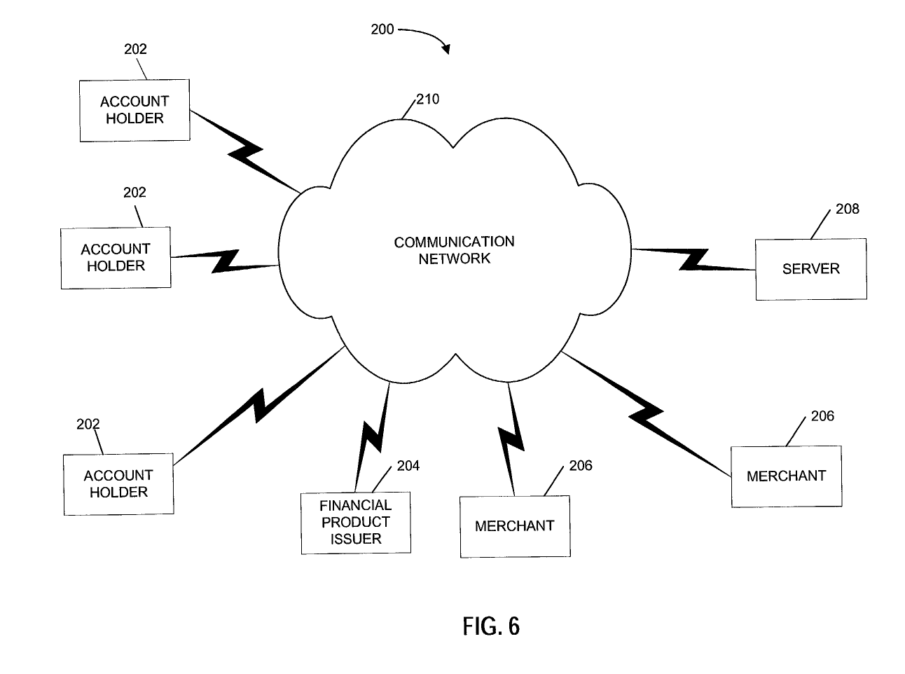

Now referring to FIG. 6, an apparatus or system 200 usable with the methods disclosed herein is illustrated. The apparatus 200 includes one or more account holder or client devices 202 that may communicate directly or indirectly with one or more financial product issuers 204, merchants 206 and servers, controllers or other devices 208 via a computer, data, or communications network 210.

All of the methods disclosed herein may be implemented by the server 208. The server 208 may be operated, used, or owned by a merchant, financial product or services company, or other entity that helps manage or provide financial accounts or products or provide strategy services to companies that provide or manage financial accounts or products.

A server 208 may implement or host a Web site. A server 208 can comprise a single device or computer, a networked set or group of devices or computers, a workstation, etc. In some embodiments, a server 208 also may function as a database server and/or as an account holder device. The use, configuration and operation of servers will be discussed in more detail below.

The account holder or client devices 202 preferably allow entities to interact with the server 208 and the remainder of the apparatus 200. The account holder devices 202 also may enable an account holder to access Web sites, software, databases, etc. hosted or operated by the servers 208. If desired, the account holder devices 202 also may be connected to or otherwise in communication with other devices. Possible account holder devices include a personal computer, portable computer, mobile or fixed account holder station, workstation, network terminal or server, cellular telephone, kiosk, dumb terminal, personal digital assistant, etc. In some embodiments, information regarding one or more account holders and/or one or more account holder devices may be stored in, or accessed from, an account holder information database and/or an account holder device information database.

A merchant includes any type of store, business, on-line retailer, etc. where an account holder may want or try to use a financial product or account during a transaction. For example, the merchant 206 may be a store that allows a customer to use a credit card to make a purchase at the merchant or otherwise conduct a transaction with the merchant. During the purchase process, the merchant 206 may request authorization from the issuer of the credit card (which might be the financial product issuer 204) to allow the customer to use the credit card. In some embodiments, the server 208 may provide a denial or approval of the authorization request. In some embodiments, a merchant might issue financial products or services to customers. For example, the merchant 206 might issue or sell credit cards, shopping cards, gift cards or certificates, etc. to one or more customers. In some embodiments, a merchant might implement some or all of the methods disclosed herein.

A financial product or account issuer 204 may include banks, lending companies, financial services companies, etc. that product financial products or accounts to account holders. For example, the financial product issuer 204 may be a company (e.g., Visa) that issues credit or debit cards to account holders and/or manages branded or private labeled credit cards for merchants. As another example, the financial product issuer 204 may be a bank that provides credit cards or debit cards to its customers. In some embodiments, a financial product issuer may implement some or all of the methods disclosed herein. In some embodiments, a financial product issuer also may be a merchant.

Many different types of implementations or hardware configurations can be used in the system 200 and with the methods disclosed herein and the methods disclosed herein are not limited to any specific hardware configuration for the system 200 or any of its components.

The communications network 210 might be or include the Internet, the World Wide Web, or some other public or private computer, cable, telephone, client/server, peer-to-peer, or communications network or intranet, as will be described in further detail below. The communications network 210 illustrated in FIG. 6 is meant only to be generally representative of cable, computer, telephone, peer-to-peer or other communication networks for purposes of elaboration and explanation of the present invention and other devices, networks, etc. may be connected to the communications network 206 without departing from the scope of the present invention. The communications network 206 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, an account holder device may be connected directly to a server 208 without departing from the scope of the present invention. Moreover, as used herein, communications include those enabled by wired or wireless technology.

Although three account holder devices 202, one financial product issuer 204, two merchants 206 and one server 208 are shown in FIG. 6, any number of such devices may be included in the system 200. The devices shown in FIG. 6 need not be in constant communication. For example, an account holder device may communicate with a server only when such communication is appropriate or necessary.

Server/Controller

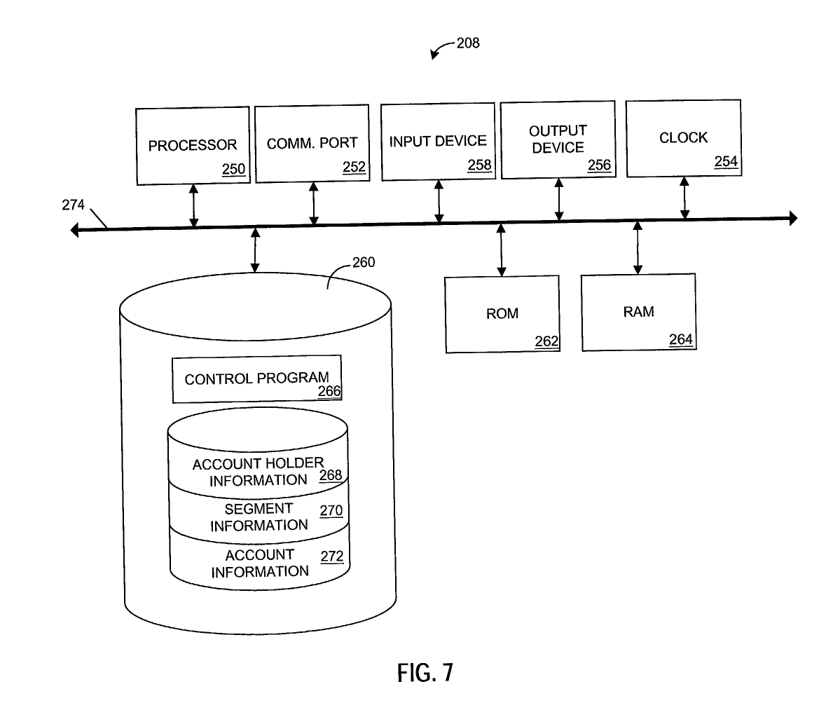

Now referring to FIG. 7, a representative block diagram of a server or controller 208is illustrated. The server 208 may include a processor, microchip, central processing unit, or computer 250 that is in communication with or otherwise uses or includes one or more communication ports 252 for communicating with account holder devices and/or other devices. Communication ports may include such things as local area network adapters, wireless communication devices, Bluetooth technology, etc. The server 208 also may include an internal clock element 254 to maintain an accurate time and date for the server 208, create time stamps for communications received or sent by the server 208, etc.

If desired, the server 208 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 208 may include a memory or data storage device 260 to store information, software, databases, communications, device drivers, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 208 also may include separate ROM 262 and RAM 264.

The processor 250 and the data storage device 260 in the server 208 each may be, for example: (i) located entirely within a single computer or other computing device; or (ii) connected to each other by a remote communication medium, such as a serial port cable, telephone line or radio frequency transceiver. In some embodiments, the server 208 may comprise one or more computers that are connected to a remote server computer for maintaining databases.

A conventional personal computer or workstation with sufficient memory and processing capability may be used as the server 208. In some embodiments, the server 208 operates as or includes a Web server for an Internet environment. The server 208 preferably is capable of high volume transaction processing, performing a significant number of mathematical calculations in processing communications and database searches. A Pentium™ microprocessor such as the Pentium III™ or IV™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 208. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 208 also may include or store information regarding account holders, account holder devices, account holder segments, accounts, merchants, credit cards or other financial products, transactions, merchants, calculations, algorithms, communications, etc. For example, information regarding one or more account holders may be stored in an account holder information database 268 for use by the server 208 or another device or entity. Information regarding one or more segments may be stored in a segment information database 270 for use by the server 208 or another device or entity and information regarding one or more accounts may be stored in an account information database 272 for use by the server 208 or another device or entity. In some embodiments, some or all of one or more of the databases may be stored or mirrored remotely from the server 208.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 274.

While specific implementations and hardware configurations for servers 208 have been illustrated, it should be noted that other implementations and hardware configurations are possible and that no specific implementation or hardware configuration is needed. Thus, not all of the components illustrated in FIG. 7 may be needed for a server implementing the methods disclosed herein. Therefore, many different types of implementations or hardware configurations can be used in the system 200 and the methods disclosed herein are not limited to any specific hardware configuration.

Account Holder Device

As mentioned above, account holder device 202 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, an account holder device 202 may have the same structure or configuration as the server 208 illustrated in FIG. 7 and include some or all of the components of the server 208.

Databases

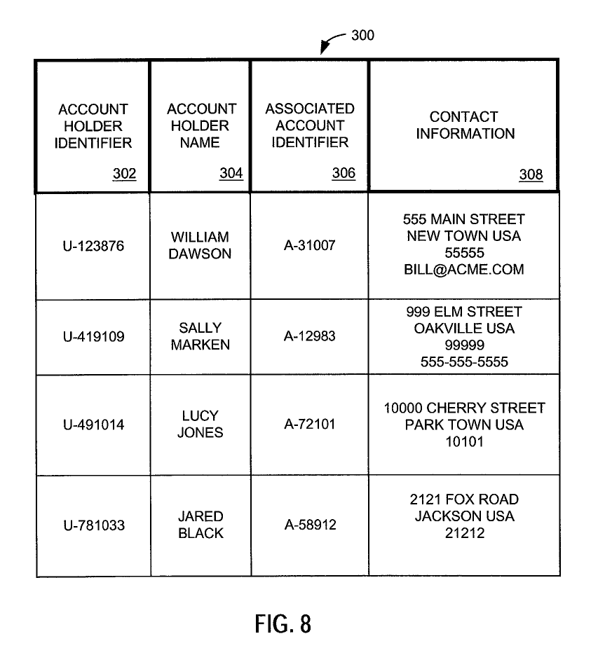

As previously discussed above, in some embodiments a server, account holder device, or other device may include or access an account holder information database for storing or keeping information regarding one or more account holders. One representative account holder information database 300 is illustrated in FIG. 8.

The account holder information database 500 may include an account holder identifier field 302 that may include codes or other identifiers for one or more account holders, an account holder name field 304 that may include names or other information regarding the account holders identified in the field 302, an associated account identifier field 306 that may includes codes or other identifiers for accounts associated with the account holders identified in the field 302, and a contact information field 308 that may include contact information (e.g., postal addresses, telephone numbers, facsimile numbers, email addresses, etc.) for the account holders identified in the field 302.

Other or different fields also may be used in the account holder information database 300. For example, in some embodiments an account holder information database may include demographic information (e.g., age, occupation, sex, annual income, nationality, preferences, hobbies, marital status, family status, etc.) regarding one or more of the account holders, information credit history, credit performance, account performance, etc. for one or more of the account holders, information regarding segments associated with account holders, information regarding shopping and purchasing history for one or more account holders, etc.

As illustrated by the account holder information database 300 of FIG. 8, the account holder identified as “U-123876” in the field 302 is named “WILLIAM DAWSON” and is associated with the account identified as “A-31007”. The account holder “U-123876” can be contacted at the postal address or email address (i.e., BILL@ACME.COM) given in the field 308.

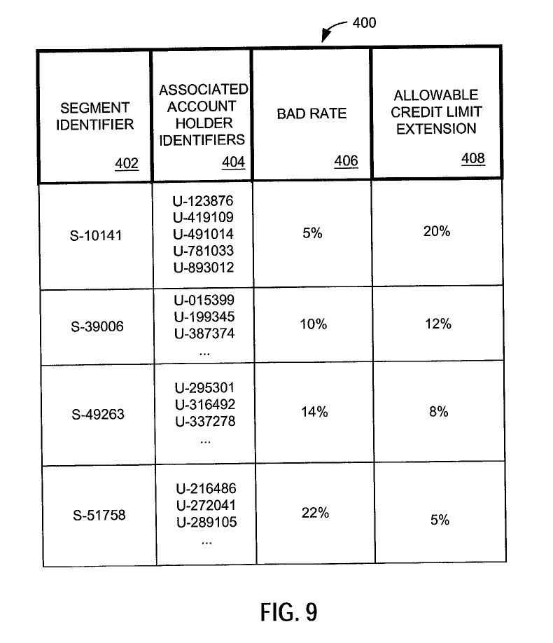

As previously discussed above, in some embodiments a server, account holder device, or other device may include or access a segment information database for storing or keeping information regarding one or more segments. One representative segment information database 400 is illustrated in FIG. 9.

The segment information database 400 may include a segment identifier field 402 that may include codes or other identifiers for one or more segments, an associated account holder identifiers field 404 that may include codes or other identifiers of account holders associated with the segments identified in the field 402, a bad rate field 406 that may include information regarding the bad rates associated with the segments identified in the field 402, and an allowable credit limit extension field 408 that may include information regarding credit limit extensions associated with the segments identified in the field 402. Note that, for purposes of simplicity, not all of the account holders identified in the field 404 are illustrated in the account holder information database 300 of FIG. 8.

Other or different fields also may be used in the segment information database 400. For example, in some embodiments a segment identifier database may include demographic and/or descriptive information regarding the segments identified in the field 402, information regarding the objective(s) used to compute the credit limit extensions provided in the field 408, information regarding the date/time the bad rates and/or the credit limit extensions were computed, information regarding the individualized optimal credit limit extension for each of the segments identified in the field 402, etc.

As illustrated by the segment information database 400 of FIG. 9, the segment identified as “S-10141” in the field 402 includes at least the five account holders identified as “U-123876”, “419109”, “U-491014”, “U-781033” and “U-893012”, has a bad rate of five percent and an allowable credit limit extension of twenty percent.

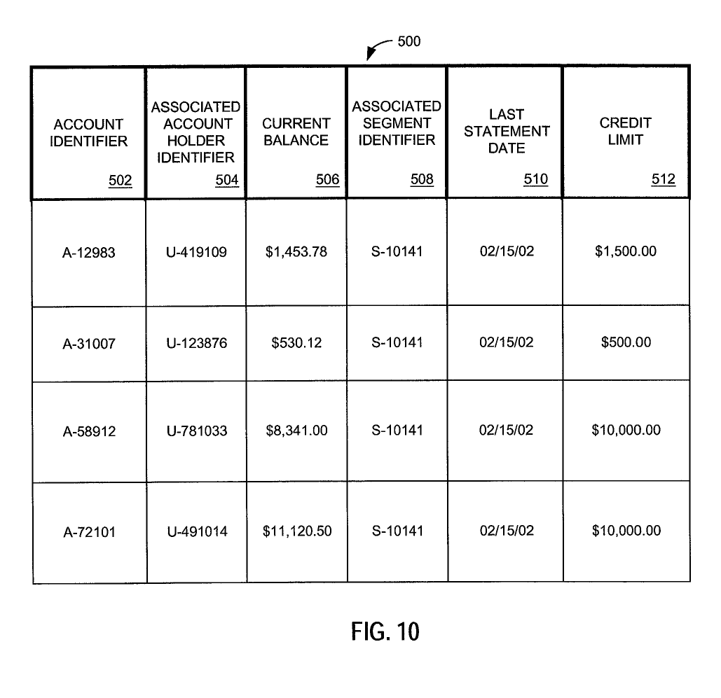

As previously discussed above, in some embodiments a server, account holder device, or other device may include or access an account information database for storing or keeping information regarding one or more accounts. One representative account information database 500 is illustrated in FIG. 10.

The account information database 500 may include an account identifier field 502 that may include codes or other identifiers for one or more accounts, an associated account holder identifier field 504 that may include codes or other identifiers for account holders associated with the accounts identified in the field 502, a current balance field 506 that may include information regarding the current balances for the accounts identified in the field 502, an associated segment identifier field 508 that may include information regarding the segments associated with the accounts identified in the field 502 and/or the account holders identified in the field 504, a last statement date field 510 that may include information regarding the last time billing or other statements were sent to the account holders identified in the field 504 regarding the accounts identified in the field 502, and a credit limit field 512 that may include information regarding credit or account limits associated with the accounts identified in the field 502.

Other or different fields also may be used in the account information database 500. For example, in some embodiments an account information database may include information regarding how and where an account holder made a payment toward the balance of an account, information regarding where and when an account holder last used an account (e.g., where did the account holder last use a credit card associated with the account), information regarding interest rates associated with accounts, information regarding delinquent or late payments made by account holders, information regarding a credit card, debit card or other financial product associated with an account, etc.

As illustrated by the account information database 500 of FIG. 10, the account identified as “A-12983 in the field 502 is associated with the account holder identified as “U-419109” and has a current balance of $1453.78. The account “A-12983” is associated with the segment identifier “S-10141”. A statement regarding the account “A-12983” was sent to the account holder “U-419109” on Feb. 15, 2002. The account “A-12983” has a credit limit of “$1,500.00”.

As previously discussed above, in some embodiments the methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Interface

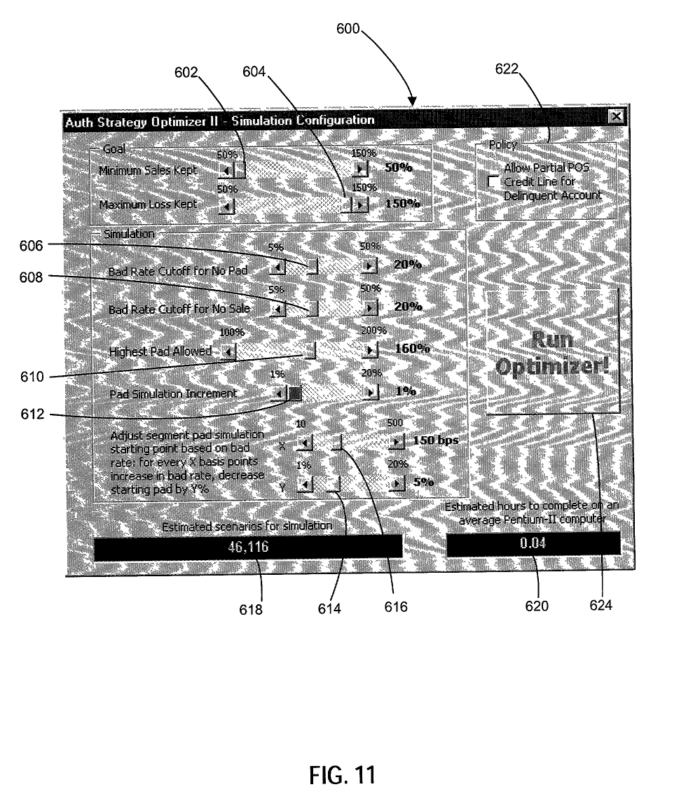

In some embodiments of the methods described herein, information and other data regarding goals, objectives, simulation conditions, etc. may be used to select a set of allowable credit limit extensions, provide bounds for or criteria for allowable sets of credit limit extensions, etc. A software dashboard or other type of interface, such as the representative interface 600 illustrated in FIG. 11, may be used to obtain or establish the information or other data. For example, the interface 600 includes a number of adjustable slides or slide bars 602, 604, 606, 608, 610, 612, 614 and 616 that may be used to establish scenarios or attributes for the methods described herein. More specifically, the settings of the slide bars 602, 604, 606, 608, 610, 612, 614 and 616 may be used during the step 104 or the step 162 to establish guidelines or parameters for determining sets of allowable credit limit extensions for segments of account holders and represent attributes used to determine the sets of allowable credit limit extensions for the segments of account holders. In some embodiments, the settings of the slide bars 602, 604, 606, 608, 610, 612, 614 and/or 616 may indicate or impose objectives or criteria used to rank or sets of allowable credit limit extensions or to aid in selecting from among potential sets of allowable credit limit extensions.

The slide bars 602 and 604 may be used in the interface 600 to establish the range of allowable outcomes of sets of allowable credit limit extensions. More specifically, the slide bar 602 may allow a user of the interface 600 to indicate a range between fifty percent and one hundred and fifty percent for minimum sales kept for a set of allowable credit limit extensions. The minimum sales kept slide or bar 602 reflects or indicates the threshold of “expected sales percentage” (see Table 5). For example, if the slide 602 is set at fifty percent, only combinations of allowable credit limit extensions having expected sales percentages greater than or equal to fifty percent will be output for review or considered for use..

The slide bar 604 may allow a user of the interface 600 to indicate a range between fifty percent and one hundred and fifty percent for maximum loss kept for a set of allowable credit limit extensions. The maximum loss kept slide 604 reflects or indicates the threshold of “bad sales kept percentage” (see Table 5). For example, if the slide 604 is set at one hundred and fifty percent, only combinations of allowable credit limit extensions having expected bad sales percentages equal to one hundred and fifty percent or lower will be output for review or considered for use.

The slide 606 may allow a user of the interface 600 to indicate a range between five percent and fifty percent for bad rate cutoff at which no credit limit extension can be granted to a segment. For example, if the slide 606 is set at twenty percent, a segment that has a bad rate or twenty percent or greater is not allowed to have a pad percentage greater than one hundred percent.

The slide 608 may allow a user of the interface 600 to indicate a range between five percent and fifty percent for bad rate cutoff at which no sale can be authorized. For example, if the slide 608 is set at twenty percent, an account holder in a segment having a bad rate of twenty percent or higher will not be allowed to make any sale or conduct any transaction, even though the account holder has a valid credit line. Thus, the account holder has a zero pad percentage or a minus one hundred percentage credit limit extension (e.g. a credit limit limitation)..

The slide 610 may allow a user of the interface 600 to indicate the highest allowable pad percentage that a segment is allowed to have. For example, if the slide 610 is set at one hundred and sixty percent, no set of credit limit extensions will be considered or allowed wherein a segment as a pad percentage greater than one hundred and sixty percent. Typically, only the segment having the best bad rate will be able to have the maximum pad percentage established by the slide 610, with the maximum pad percentages for other segments determined relative to the best segment by the settings of the slides 614, 616, as will be discussed in more detail below.

The slide 612 may allow a user of the interface 600 to indicate the pad percentage simulation increment for evaluation of segments. For example, suppose the slide 612 is set at one percent. Increments of possible pad percentages may then be checked at one percent intervals. Thus, if pad percentages for the three segments A, B, C, are allowed to vary between one hundred percent and one hundred and ten percent at one percent increments, 1,331 possible sets of pad percentages are possible for the three segments A, B, C (e.g., 100% for A, 100% for B, 100% for C; 100% for A, 100% for B, 101% for C; 100% for A, 100% for B, 103% for C; 100% for A, 100% for B, 105% for C; . . . , 110% for A, 110% for B, 107% for C; 110% for A, 110% for B, 108% for C; 110% for A, 110% for B, 109% for C; 110% for A, 110% for B, 110% for C) since there are eleven possible pad percentages (e.g., 100%, 101%, 102%, 103%, 104%, 105%, 106%, 107%, 108%, 109%, 110%) for each of the segments A, B, C. If pad percentages for the three segments A, B, C, are allowed to vary between one hundred percent and one hundred and ten percent at five percent increments, only twenty-seven possible sets of pad percentages are possible for the three segments A, B, C (e.g., 100% for A, 100% for B, 100% for C; 100% for A, 100% for B, 105% for C; 100% for A, 100% for B, 110% for C; 100% for A, 105% for B, 100% for C, 110% for A, 105% for B, 105% for C; . . . , 110% for A, 110% for B, 100% for C; 110% for A, 110% for B, 105% for C; 110% for A, 110% for B, 110% for C) since there are only three possible pad percentages (e.g., 100%, 105%, 110%) for each of the segments A, B, C.

The slides 614, 616 may allow a user of the interface 600 to indicate for each segment a maximum allowed pad percentage relative to the maximum pad set by the slide 610.. For example, the slide 610 provides an indication of the best possible pad that will be allowed for the best segment with regard to bad rates. The slides 614, 616 then lower the maximum pad for other segments based on their bad rates relative to the bad rate of the best segment (e.g., the segment having the lowest bad rate). If the slide 614 is set at five percent and the slide 616 is set at one hundred and fifty basis points, then for a particular segment, for each one hundred and fifty basis points that the bad rate of the segment is higher than the bad rate of the best segment, then the maximum pad percentage allowed for the segment will be five percent lower than the maximum pad percentage allowed for the best segment as set by the slide 610.

The interface 600 also may predict the number of scenarios to be tested given the given the configuration or position of the slide bars 602, 604, 606, 608, 610, 612, 614 and 616. For example, 46,116 estimated scenarios exist for the settings of the slide bars 602, 604, 606, 608, 610, 612, 614 and 616 provided in FIG. 11, as illustrated by the text bar 618. A scenario represents different combinations of the options provided in Table 5 as governed by the settings of the interface 600. The expected number of potential scenarios may vary depending on the settings in the interface 600 and the number of size of account holder segments.

In addition to the expected number of scenarios, the interface 600 also may estimate the number of hours to complete the computation and evaluation of sets of allowable credit limit extensions given the configuration of the slide bars 602, 604, 606, 608, 610, 612, 614 and 616. For example, for the settings of the slide bars 602, 604, 606, 608, 610, 612, 614 and 616 provided in FIG. 11, it is expected that 0.04 hours will be needed to conduct the computation and evaluation on an average Pentium™ II based computer, as illustrated by the text bar 620. Such a time estimate can be calculated by dividing the number of scenarios by three hundred evaluations a second.

Changing the sets of the slide bars 602, 604, 606, 608, 610, 612, 614 and 616 may result in fewer or more scenarios being evaluated, thereby taking longer time while also potentially providing an expanded list or table of potential sets of allowable credit limit extensions. Thus, a user can balance and decide between a need for a quick solution versus a need for a complete list or table of potential sets of allowable credit limit extensions when setting the position of the adjustable slide bars 602, 604, 606, 608, 610, 612, 614 and 616. A fewer number of scenarios typically will result in quicker processing while a increased number of scenarios typically will result in longer processing time, but may lead to a better overall solution.

In some embodiments, one or more policies may be established or used to provide additional guidelines for segments and/or credit limit extensions. For example, the policy provided in the block 622 may allow a partial credit limit to be assigned to a segment or used by account holders in the segment if the policy is selected or enabled. If the block 622 is not checked or selected, then a pad percentage of zero percent (as set by the slide 606) or one hundred percent or greater is allowed. If the block 622 is checked or selected, any pad percentage is possible for a segment up to the maximum pad percentage set by the slides 610, 614, 616 (including, but not limited to, pad percentages greater than zero percent and less than one hundred percent).

Once all settings for the interface 600 are set, a user may initiate the simulation of potential sets of credit limit extensions by selecting or clicking on the button 624. A device, software program or entity using the interface 600 may take previously determined segments of users (e.g., the segments determined during the step 102) and create sets of allowable credit limit extensions based on the settings of the interface 600. The information provided in Table 5 above may be the result of such operation.

The interface 600 may be part of, or included in, a computer program or other software product used for determining sets of potential credit limit extensions for segments of users. The adjustable settings provided by the slides or slide bars 602, 604, 606, 608, 610, 612, 614 and 616 provided a plurality of adjustable settings for a respective plurality of attributes that can be used in determining a plurality of sets of potential credit limit extensions guided during the step 104 or the sep 162.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for determining credit limit extensions for segments of account holders, comprising:
determining a plurality of segments of account holders, wherein each of said account holders has an associated financial account and each of said segments includes at least one of said account holders;
determining at least one objective associated with all of said segments; and
determining a set of allowable credit limit extensions for said segments based on said at least one objective.

2. The method of claim 1, wherein said determining a plurality of segments of account holders, includes at least one of the following:
determining information regarding a segmentation of a plurality of account holders;
receiving data indicative of said plurality of segments; and
retrieving data indicative of said plurality of segments.

3. The method of claim 1, wherein said determining at least one objective associated with all of said segments includes at least one of the following:
determining, for at least one of said plurality of segments, at least one utilization level of accounts by account holders in said at least one of said plurality of segments; and
determining, for each of said plurality of segments, at least one utilization level of accounts by account holders.

4. The method of claim 1, wherein said determining at least one objective associated with all of said segments includes:
determining, for each of said plurality of segments, at least one utilization level of accounts by account holders, wherein each utilization level will have at least one associated transaction;
determining, for each utilization level, a bad amount and charge amount associated with transactions for said utilization level; and
determining changes in expected charge amounts and expected bad amounts for different sets of credit limit extensions for said plurality of segments.

5. The method of claim 1, wherein said determining a set of allowable credit limit extensions for said segments based on said at least one objective includes determining, for each of said segments, an allowable extension of a credit limit such that said at least one objective is reached for the segment individually.

6. The method of claim 5, wherein said determining a set of allowable credit limit extensions for said segments based on said at least one objective includes determining a bad rate for each of said segments.

7. The method of claim 1, wherein said determining a set of allowable credit limit extensions for said segments based on said at least one objective includes determining, for each of said segments, an allowable extension of a credit limit such that said at least one objective is optimized for the segment individually.

8. The method of claim 1, further comprising:
authorizing a transaction based said set of allowable credit limit extensions.

9. The method of claim 1, wherein said at least one objective includes at least one of the following:
maximizing amount of uses of financial accounts by account holders;
a maximum allowable credit limit extension;
a minimum amount of use of financial accounts by account holders;
a maximum amount of losses resulting from use of financial accounts by account holders;
a maximum credit limit extension for an account holder in a segment having a bad rate exceeding a designated amount;
a zero credit limit extension for an account holder in a segment having a bad rate exceeding a designated amount; and
a lack of authorization to use a financial account by an account holder in a segment having a bad rate exceeding a designated amount.

10. The method of claim 1, further comprising:
providing data indicative of said set of credit line extensions.

11. The method of claim 1, wherein a credit limit extension determined for a segment is indicative of an optimal offset between losses and sales associated with said segment in light of said at least one objective.

12. The method of claim 1, wherein said set of credit line extensions determined for said segments are indicative of an optimal offsets between all losses and sales associated with all of said segments in light of said at least one objective.

13. The method of claim 1, further comprising:
providing data indicative of said of at least one of said set of allowable credit limit extensions.

14. A method for determining credit limit extensions for at least two different segments of account holders, comprising:
determining a plurality of segments of account holders, wherein each of said account holders has an associated financial account and each of said segments includes at least one of said account holders; and
determining a plurality of sets of allowable credit limit extensions for said segments.

15. The method of claim 14, further comprising:
determining at least one objective;

16. The method of claim 15, further comprising:
selecting one of said plurality of sets based, at least in part, on said at least one objective.

17. The method of claim 14, further comprising:
providing data indicative of said plurality of sets of allowable credit limit extensions.

18. The method of claim 14, further comprising:
providing data indicative of at least one of said plurality of sets of allowable credit limit extensions.

19. The method of claim 14, further comprising:
authorizing a transaction based on one of said sets of allowable credit limit extensions.

20. A method for determining credit card limit extensions for account holders of the credit cards, comprising:
determining, for a group of segments of account holders of credit cards, a plurality of sets of allowable credit limit extensions;
determining at least one objective; and
selecting one of the sets of allowable credit limit extensions based, at least in part, on said at least one objective.

21. A method for determining credit card limit extensions for account holders of the credit cards, comprising:
determining, for a group of segments of account holders of credit cards, a plurality of sets of allowable credit limit extensions; and
selecting one of said sets of allowable credit limit extensions.

22. A computer program product in a computer readable medium for determining sets of potential credit limit extensions for segments of account holders, comprising:
first instructions for providing an interface, wherein said interface includes a plurality of adjustable settings for a respective plurality of attributes; and
second instructions for determining a plurality of sets of potential credit limit extensions for the segments guided, at least in part, by said plurality of adjustable settings.

23. A system for determining credit limit extensions for segments of account holders, comprising:
a memory;
a communication port; and
a processor connected to said memory and said communication port, said processor being operative to:
determine a plurality of segments of account holders, wherein each of said account holders has an associated financial account and each of said segments includes at least one of said account holders;
determine at least one objective associated with all of said segments; and
determine a set of allowable credit limit extensions for said segments based on said at least one objective.

24. A computer program product in a computer readable medium for determining credit limit extensions for segments of account holders, comprising:
first instructions for identifying a plurality of segments of account holders, wherein each of said account holders has an associated financial account and each of said segments includes at least one of said account holders;
second instructions for identifying at least one objective associated with all of said segments; and
third instructions for selecting a set of allowable credit limit extensions for said segments based on said at least one objective.

25. A system for associating a set of credit limit extensions with a plurality of segments of account holders, comprising:
a memory,
a communication port; and
a processor connected to said memory and said communication port, said processor being operative to:
determine, for a group of segments of account holders of credit cards, a plurality of sets of allowable credit limit extensions; and
select one of said sets of allowable credit limit extensions.

26. A computer program product in a computer readable medium for associating a set of credit limit extensions with a plurality of segments of account holders, comprising:
first instructions for identifying, for a group of segments of account holders of credit cards, a plurality of sets of allowable credit limit extensions; and
second instructions for choosing one of said sets of allowable credit limit extensions.
